(19) United States
(12) Patent Application Publication
(10) Pub. No.: US 2013/0328417 A1
(43) Pub. Date: Dec. 12, 2013

(54) POWER TRANSMITTING APPARATUS, POWER RECEIVING APPARATUS, AND POWER TRANSMITTING METHOD

(71) Applicant: Kazuma Takeuchi, Osaka (JP)

(72) Inventor: Kazuma Takeuchi, Osaka (JP)

(73) Assignee: PANASONIC CORPORATION, Osaka (JP)

(21) Appl. No.: 13/985,645

(22) PCT Filed: Feb. 3, 2012
(86) PCT No.: PCT/JP2012/000735

§ 371 Date: Aug. 15, 2013

(30) Foreign Application Priority Data
Feb. 17, 2011 (JP) 2011-031867

(51) Int. Cl. H02J 17/00

(52) U.S. Cl. CPC H02J 17/00
USPC 307/149

(57) ABSTRACT

Provided is a electric power transmitting apparatus (300) that has sub-electric power transmission mode, and main electric power transmission mode for transmitting power larger than that transmitted in the sub-electric power transmission mode. A power transmitting unit (310) transmits power in a wireless manner. A electric power transmission control unit (320) controls, in sub-electric power transmission mode, power to be transmitted by means of the power transmitting unit (310) and transmission timing of the electric power transmission such that at least power that the electric power receiving apparatus needs to transmit power request notification is transmitted at random intervals. A electric power transmission control unit (320) performs switching to the main electric power transmission mode, in the cases where a communication unit (350) acquired the power request notification transmitted from the electric power receiving apparatus.

### TECHNICAL FIELD

The present invention relates to a electric power transmitting apparatus, a electric power receiving apparatus, and a electric power transmitting method that perform non-contact electric power transmission.

### BACKGROUND ART

Non-contact electric power transmission technology has come into widespread use in recent years in areas including IC (integrated circuit) cards and electronic money systems.

Research is also being vigorously pursued regarding wireless electric power transmission methods that enable long-distance transmission in comparison to non-contact electric power transmission technology. Wireless electric power transmission methods are broadly divided into the following three methods: a method that utilizes electromagnetic induction (electromagnetic induction method), a method that utilizes radio waves (radio wave transmission method), and a method that utilizes magnetic-field resonance (magnetic-field resonance method).

The electromagnetic induction method uses two coils, and realizes electric power transmission by utilizing an induced current that arises in a coil on a power receiving side that is induced by a magnetic field generated by a coil on a power transmitting side. The distance over which transmission is possible when using the electromagnetic induction method is generally short.

According to the radio wave transmission method, electromagnetic waves that are propagated through a space are received by an antenna (rectenna (rectifying antenna)), and energy of the electromagnetic waves is acquired as power. The amount of power that the radio wave transmission method can transmit is small because the electromagnetic waves that are propagated through a space do not hold a very large amount of energy.

The magnetic-field resonance method uses two coils, and realizes electric power transmission between separated circuits by utilizing a resonance phenomenon between resonators electromagnetically coupled by a magnetic field (or electric field). In the magnetic-field resonance method, by increasing the coupling strength and a Q value of the coils, the transmission distance can be extended and the transmittable power is also comparatively large in comparison to the electromagnetic induction method.

As a wireless electric power transmission method of the related art, Patent Literature (hereinafter, referred to as “PTL”) 1 discloses a method in which a device that requires power transmits a signal requesting power (power request notification signal) to a device capable of transmitting power, and the device capable of transmitting power carries out electric power transmission. PTL 1 also discloses a method that reduces interference by a plurality of devices capable of transmitting power performing time division or frequency division.

### CITATION LIST

### Patent Literature

### PTL 1

Japanese Patent Application Laid-Open No, 2009-268310

### SUMMARY OF INVENTION

### Technical Problem

However, according to the technology described in PTL 1 that utilizes frequency division, in a case where a device that requires power has consumed so much power that the device cannot even transmit a power request notification signal, no power request notification signal is transmitted. Therefore, it is difficult for a device capable of transmitting power to transmit power to the device that requires power.

Further, in a wireless electric power transmission system including a plurality of electric power transmitting apparatuses and electric power receiving apparatuses, when a plurality of electric power transmitting apparatuses and electric power receiving apparatuses mainly utilize the same frequency as a electric power transmission frequency to perform time-division electric power transmission, the time-division electric power transmission is applied to a electric power receiving apparatus that is at a remote distance and that does not cause interference, so that such a system is inefficient.

An object of the present invention is to provide a electric power transmitting apparatus, a electric power receiving apparatus, and a electric power transmitting method that allow electric power transmission to be started even in a case where a electric power receiving apparatus does not have even enough remaining power to request electric power transmission in a wireless electric power transmission system in which a plurality of electric power transmitting apparatuses and electric power receiving apparatuses mainly utilize an identical frequency as a electric power transmission frequency.

### Solution to Problem

A electric power transmitting apparatus according to an aspect of the present invention is a electric power transmitting apparatus that has a sub-electric power transmission mode, and a main electric power transmission mode in which a larger amount of power than an amount of power transmitted in the sub-electric power transmission mode is transmitted, and that transmits power to a electric power receiving apparatus in a manner in which a plurality of electric power transmitting apparatuses and electric power receiving apparatuses mainly utilize an identical frequency as a electric power transmission frequency, the electric power transmitting apparatus including: a power transmitting section that transmits power wirelessly; a communication section that acquires a power request notification to be transmitted from the electric power receiving apparatus; and a electric power transmission control section that, as the sub-electric power transmission mode, controls power to be transmitted by the power transmitting section and a transmission timing of the power so that at least power required for the electric power receiving apparatus to transmit the power request notification is transmitted at random time intervals, and that switches to the main electric power transmission mode in a ease where the communication section acquires the power request notification.

A electric power receiving apparatus according to an aspect of the present invention is a electric power receiving apparatus that receives, from a electric power transmitting apparatus, power transmitted in a manner in which a plurality of electric power transmitting apparatuses and electric power receiving apparatuses mainly utilize an identical frequency as a electric power transmission frequency, the electric power transmitting apparatus Having a main electric power transmission mode, and a sub-electric power transmission mode in which a smaller amount of power than an amount of power transmitted in the main electric power transmission mode is transmitted, the electric power receiving apparatus including: a power receiving section that receives power transmitted wirelessly front the electric power transmitting apparatus; a reception level determining section that monitors a power reception state at the power receiving section and that detects an occurrence of interference based on a change in the power reception state; and a communication section that sends a power request notification, information showing the power reception state, or an interference detection notification that indicates the occurrence of interference to the electric power transmitting apparatus.

A electric power transmitting method according to an aspect of the present invention is a electric power transmitting method that transmits power from a electric power transmitting apparatus to a electric power receiving apparatus in a manner in which a plurality of electric power transmitting apparatuses and electric power receiving apparatuses mainly utilize an identical frequency as a electric power transmission frequency, the electric power transmitting apparatus having a sub-electric power transmission mode and a main electric power transmission mode in which a larger amount of power than an amount of power transmitted in the sub-electric power transmission mode is transmitted, the electric power transmitting method including: transmitting power wirelessly; acquiring a power request notification to be transmitted from the electric power receiving apparatus; controlling, as the sub-electric power transmission mode, power to be transmitted and a transmission timing of the power so that at least power required for the electric power receiving apparatus to transmit the power request notification is transmitted at random time intervals; and switching to the main electric power transmission mode in a case where the power request notification is acquired.

### Advantageous Effects of Invention

According to the present invention, in a wireless electric power transmission system in which a plurality of electric power transmitting apparatuses and electric power receiving apparatuses mainly utilize the same frequency as a electric power transmission frequency, electric power transmission can be started even in a case where a electric power receiving apparatus does not have even enough remaining power to request electric power transmission.

### BRIEF DESCRIPTION OF DRAWINGS

FIG. 1 illustrates the concept of a wireless electric power transmission system according to an embodiment of the present invention;

FIG. 2 illustrates an example of the configuration of a electric power receiving apparatus according to the aforementioned embodiment;

FIG. 3 illustrates an example of the configuration of a electric, power transmitting apparatus according to the aforementioned embodiment;

FIG. 4 illustrates an example of sequences of an individual mode;

FIG. 5 illustrates an example of sequences of a hybrid mode;

FIGS. 6A to 6C illustrate a configuration example of the wireless electric power transmission system in a compound mode;

FIG. 7 illustrates an example of sequences of the compound mode;

FIG. 8 illustrates an example of optimal combinations of electric power transmitting apparatuses and output levels;

FIG. 9 is a flowchart that illustrates processing of the electric power receiving apparatus according to the aforementioned embodiment;

FIGS. 10A and 10B are flowcharts that illustrate processing performed by the electric power transmitting apparatus according to the aforementioned embodiment;

FIGS. 11A and 11B are flowcharts that illustrate processing performed by the electric power transmitting apparatus according to the aforementioned embodiment;

FIGS. 12A and 12B illustrate examples of information tables recorded by a electric power receiving apparatus management section;

FIG. 13 is a flowchart for describing a method of determining a electric power transmission method;

FIG. 14 is a flowchart for describing a method of adjusting output levels of electric power transmitting apparatuses #A and #B;

FIGS. 15A to 15C are tables for describing the method of adjusting the output levels of electric power transmitting apparatuses #A and #B;

FIG. 16 is a flowchart that illustrates output adjustment processing of the electric power transmitting apparatus in the compound mode; and

FIGS. 17A to 17I illustrate packet configurations that are used for information communication between the electric power transmitting apparatus and the electric power receiving apparatus according to the aforementioned embodiment.

### DESCRIPTION OF EMBODIMENT

An embodiment of the present invention is described in detail hereunder with reference to the accompanying drawings.

### One Embodiment

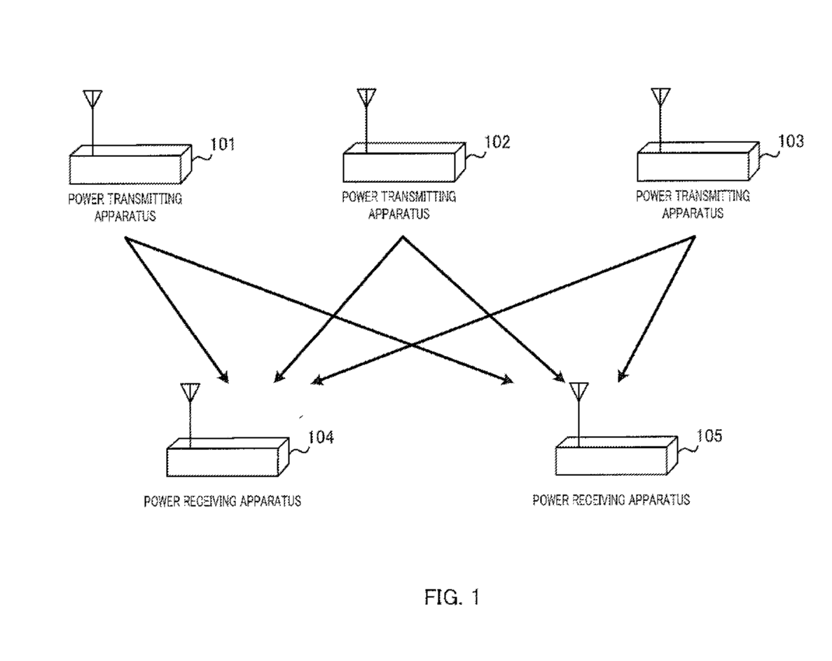

FIG. 1 illustrates an overview of a wireless electric power transmission system according to an embodiment of the present invention.

The wireless electric power transmission system shown in FIG. 1 is an example that realizes wireless electric power transmission in which, for example, a plurality of electric power transmitting apparatuses 101 to 103 and electric power receiving apparatuses 104 and 105 use magnetic-field resonance of mainly the same common frequency as a electric power transmission frequency. Note that although the wireless electric power transmission system shown in FIG. 1 includes three electric power transmitting apparatuses and two electric power receiving apparatuses, the number of electric power transmitting apparatuses and electric power receiving apparatuses of the wireless electric power transmission system is not limited to this example.

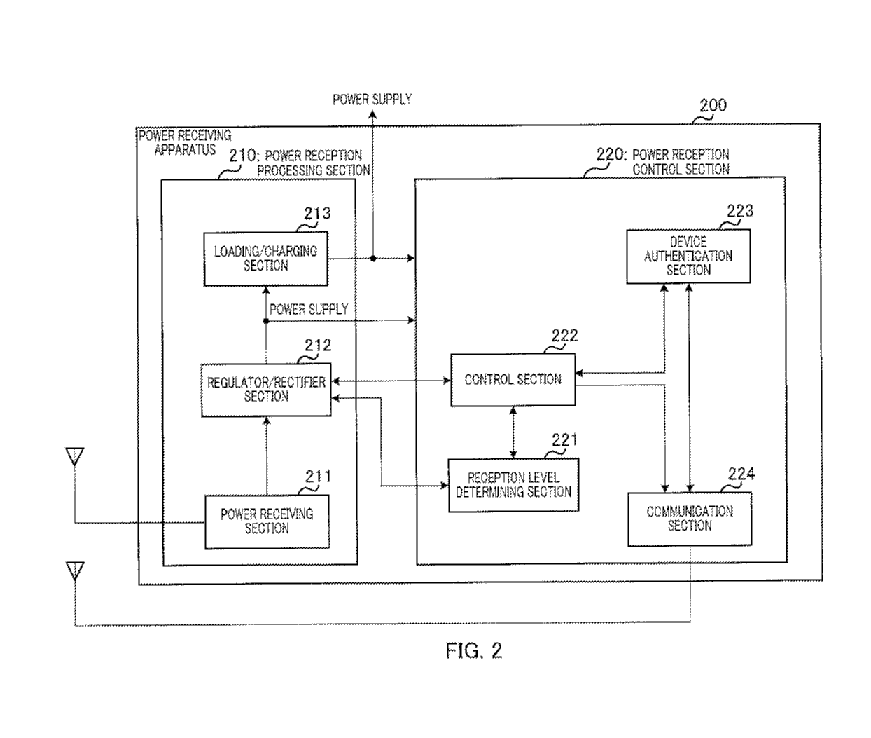

FIG. 2 is a block diagram that illustrates an example of the configuration of a electric power receiving apparatus according to the present embodiment. Electric power receiving apparatus 200 shown FIG. 2 is applied to electric power receiving apparatuses 104 and 105 shown in FIG. 1.

In FIG. 2, electric power receiving apparatus 200 according to the present embodiment includes power reception processing section 210 and power reception control section 220. Power reception processing section 210 includes power receiving section 211, regulator/rectifier section 12, and loading/charging section 213. Power reception control section 220 includes reception level determining section 221, control section 222, device authentication section 223, and communication section 224.

Power receiving section 211 receives power that is transmitted from a electric power transmitting apparatus, described later, through an antenna, and supplies the received power to regulator/rectifier section 212.

Regulator/rectifier section 212 rectifies and stabilizes the power that has been supplied from power receiving section 211, and thereafter supplies the power to a supply destination that is designated by control section 222. Regulator/rectifier section 212 can be configured, for example, by combining a bridge-type rectifier circuit and a voltage regulator IC (integrated circuit) or the like.

Loading/charging section 213 receives power that is supplied, from regulator/rectifier section 212, and supplies the power to power reception control section 220 or to a device connected to electric power receiving apparatus 200. Loading/charging section 213, for example, is a secondary battery or capacitor or an electronic device.

Reception level determining section 221 monitors the power reception state based on the state of power that is supplied from regulator/rectifier section 212. For example, reception level determining section 221 can monitor the power reception state by temporarily storing power that has been outputted from regulator/rectifier section 212 in a capacitor, and identifying the reception level (electric potential) thereof. In a case where the reception level has changed, reception level determining section 221 determines that interference has occurred, and sends an interference detection notification to control section 222.

Control section 222 requests device authentication section 223 to perform processing to request electric power transmission. In the present embodiment, an example is described in which control section 222 requests device authentication section 223 to perform authentication processing as processing to request electric power transmission. In addition, upon receiving a notification from reception level determining section 221 to the effect that the reception level has changed, that is, that interference has been detected (hereunder, referred to as “interference detection notification”), control section 222 requests communication section 224 to transmit an interference detection notification. Subsequently, control section 222 receives power that is transmitted as a test transmission from each of the electric power transmitting apparatuses, described later, and requests communication section 224 to transmit information regarding the reception level of the received power. The operations of control section 222 are described in detail later.

Note that regulator/rectifier section 212 is set as an initial state so as to supply power received by electric power transmission only to power reception control section 220 when there is no remaining power in electric power receiving apparatus #1. Therefore, even when there is no power remaining in electric power receiving apparatus #1, electric power receiving apparatus #1 can surely send a power request notification using power received by electric power transmission that is transmitted at irregular intervals from electric power transmitting apparatus #1 in the sub-electric power transmission mode. Accordingly, in this case also, it is possible for electric power transmitting apparatus #1 to start electric power transmission with respect to electric power receiving apparatus #1. Note that, after electric power transmission has started, control section 222 designates the supply destination of the power to regulator/rectifier section 212.

Upon receiving an authentication processing request as processing to request electric power transmission from control section 222, device authentication section 223 performs authentication processing with a electric power transmitting apparatus through communication section 224. When device authentication section 223 receives a request for authentication processing from control section 222, device authentication section 223 requests communication section 224 to transmit an authentication request notification as a power request notification. Subsequently, if device authentication section 223 receives an authentication completion notification with respect to the authentication request notification to indicate that authentication is successful, device authentication section 223 notifies control section 222 that power reception is starting as a notification to the effect that the power request was accepted.

When communication section 224 is requested by control section 222 to transmit an interference detection notification, communication section 224 transmits the interference detection notification to a electric power transmitting apparatus that is described later. Further, when communication section 224 is requested by control section 222 to transmit information regarding a reception level, communication section 224 transmits the relevant reception level information as a reception level notification to a electric power transmitting apparatus that is described later. In addition, when communication section 224 is requested by device authentication section 223 to perform authentication processing, communication section 224 transmits an authentication request notification to a electric power transmitting apparatus that is described later, Furthermore, upon receiving an authentication completion notification from a electric power transmitting apparatus that is described later, communication section 224 sends the authentication completion notification to device authentication section 223. Communication section 224 performs communication with a electric power transmitting apparatus, described later, utilizing, for example, specified low power radio, Bluetooth, wireless LAN, infrared-ray communication or Zigbee.

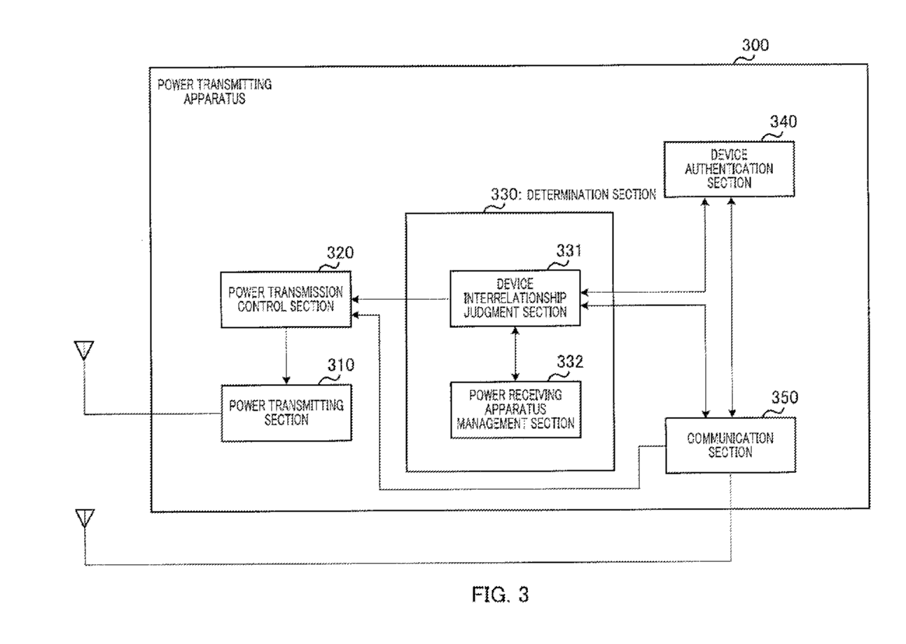

FIG. 3 is a block diagram illustrating an example of the configuration of a electric power transmitting apparatus according to the present embodiment. Electric power transmitting apparatus 300 shown in FIG. 3 is applied to electric power transmitting apparatuses 101 to 103 shown in FIG. 1.

According to the present embodiment, electric power transmitting apparatus 300 includes a main electric, power transmission mode and a sub-electric power transmission mode as operation modes. Although both the main electric power transmission mode and the sub-electric power transmission mode perform electric power transmission to a electric power receiving apparatus, the main electric power transmission mode is a mode that transmits a larger amount of power than an amount of power to be transmitted in the sub-electric power transmission mode. The sub-electric power transmission mode is a mode that, even when the electric power receiving apparatus does not have even enough remaining power to request electric power) transmission, transmits power of an amount so that, by receiving the power transmitted in the sub-electric power transmission mode, the electric power receiving apparatus can at least request electric power transmission.

Note that a power value is determined by multiplying the output level by the electric power transmission period. Hereunder, a electric power transmission period that is set at a time of the main electric power transmission mode and a electric power transmission period that is set at a time of a sub-electric power transmission mode are referred to as a “main electric power transmission period” and a “sub-electric power transmission period”, respectively. The main electric power transmission period is longer than the “sub-electric power transmission period”, and the amount of power to be transmitted in the main electric power transmission mode (hereunder, referred to as “main power”) is greater than the amount of power to be transmitted in the sub-electric power transmission mode (hereunder, referred to as “sub-power”).

Electric power transmitting apparatus 300 includes power transmitting section 310, electric power transmission control section 320, determination section 330, device authentication section 340, and communication section 350. Determination section 330 includes device interrelationship judgment section 331 and electric power receiving apparatus management section 332.

Power transmitting section 310 performs electric power transmission to an unshown electric power receiving apparatus in a manner in which the amount of power to be transmitted and the electric power transmission timing are controlled by electric power transmission control section 320.

Electric power transmission control section 320 switches between the main electric power transmission mode and the sub-electric power transmission mode by controlling the power to be transmitted by power transmitting section 310 and the transmission timing. In the sub-electric power transmission mode, electric power transmission control section 320 controls the sub-power (that the sub-electric power transmission, period) so that at least the power required for a electric power receiving apparatus to transmit a power request notification is transmitted from power transmitting section 310. Further, in the sub-electric power transmission mode, electric, power transmission control section 320 controls the transmission timing so that the sub-power is transmitted at random time intervals.

In addition, in the main electric power transmission mode, electric power transmission control section 320 instructs power transmitting section 310 to start transmission based on a determination result of determination section 330. Specifically, based on the aforementioned determination result, electric power transmission control section 320 controls the transmission timing of the electric power transmission and the main power (that is, the main electric power transmission period), and instructs power transmitting section 310 to start transmission.

Upon receiving a notification of an interference detection result from each of the electric power receiving apparatuses from communication section 350, electric power transmission control section 320 switches to the sub-electric power transmission mode. Further, electric power transmission control section 320 controls the transmission timing of a power test transmission notification so that the power test transmission notification does not overlap with a power test transmission notification from another electric power transmitting apparatus. For example, electric power transmission control section 320 controls the transmission timing of the power test transmission notification so as to transmit the power test transmission notification at random time intervals. Thereafter, electric power transmission control section 320 performs electric power transmission of the sub-power as a test transmission of power.

Upon receiving a reception level notification from each of the electric power receiving apparatuses from communication section 350, device interrelationship judgment section 331 sends information regarding the reception levels between the electric power receiving apparatuses and the electric power transmitting apparatus to electric power receiving apparatus management section 332.

In a case where device authentication section 340 authenticates the electric power receiving apparatus described above, or when communication section 350 receives an interference detection notification, device interrelationship judgment section 331 determines the electric power transmission method. The method of determining the electric power transmission method is described later. Device interrelationship judgment section 331 notifies electric power transmission control section 320 of the determined electric power transmission method.

Electric power receiving apparatus management section 332 records the reception level of each electric power receiving apparatus notified by device interrelationship judgment section 331. Further, in response to an inquiry from device interrelationship judgment section 331 electric power receiving apparatus management section 332 provides information regarding the recorded reception level of each electric power receiving apparatus to device interrelationship judgment section 331.

Upon receiving an authentication request notification as a power request notification from the above described electric power receiving apparatus from communication section 350, device authentication section 340 performs authentication processing with the relevant electric power receiving apparatus through communication section 350. For example, device authentication section 340 compares registration information that is previously registered in the wireless electric power transmission system and authentication information that is included in the authentication processing request, and if the comparison result indicates that the registration information and authentication information match, device authentication section 340 determines that authentication is successful. The registration information and authentication information are, for example, a electric power receiving apparatus ID (identification) or the like. If authentication is successful, device authentication section 340 sends an authentication completion notification to device interrelationship judgment section 331 and communication section 350. In contrast, if authentication fails, device authentication section 340 does not perform any subsequent processing and ends the current processing.

Communication section 350 acquires an authentication request notification or an interference detection result that is sent from the above-described electric power receiving apparatus. Communication section 350 performs communication with the above-described electric power receiving apparatus utilizing, for example, specified low power radio, Bluetooth, wireless LAN, infrared-ray communication, Zigbee, or the like. Communication section 350 sends an acquired authentication request notification to device authentication section 340. Further, communication section 350 sends an acquired interference detection result to device interrelationship judgment section 331.

Communication section 350 also transmits the authentication completion notification received from device authentication section 340 to the above-described electric power receiving apparatus 200. Further, if communication section 350 acquired an interference detection result, communication section 350 transmits a power test transmission notification to the above-described electric power receiving apparatus 200.

Thus, electric power receiving apparatus 200 receives power transmitted from electric power transmitting apparatus 300, rectifies and regulates the power, and supplies the power to loading/charging section 213. Further, electric power receiving apparatus 200 transmits an authentication request notification to electric power transmitting apparatus 300, and receives power transmitted from electric power transmitting apparatus 300.

In a case where the reception level changes significantly, electric power receiving apparatus 200 switches electric power transmitting apparatus 300 from which to receive transmitted power, by transmitting an interference detection notification to electric power transmitting apparatus 300.

Further, in the sub-electric power transmission mode, electric power transmitting apparatus 300 transmits the sub-power at random time intervals. Upon receiving an authentication request notification as a power request notification from electric power receiving apparatus 200, electric power transmitting apparatus 300 performs authentication processing. If the result of the authentication processing indicates that electric power transmission is possible, electric power transmitting apparatus 300 transitions to the main electric power transmission mode and starts electric power transmission of the main power to the authenticated electric power receiving apparatus. Further, upon receipt of an interference detection notification, electric power transmitting apparatus 300 transitions to the sub-electric power transmission mode so that an appropriate electric power transmitting apparatus 300 to perform electric power transmission is determined.

Next, sequences of information communication and electric power transmission between a electric power transmitting apparatus and a electric power receiving apparatus according to the present embodiment are described.

Note that, the wireless electric power transmission system according to the present embodiment includes an individual mode, a hybrid mode, and a compound mode as electric power transmission methods.

The individual mode is a mode in which point to point electric power transmission is performed between the electric power transmitting apparatus and the electric power receiving apparatus.

The hybrid mode is a mode in which electric power transmission is performed from a plurality of electric power transmitting apparatuses to a certain electric power receiving apparatus.

The compound mode is a mode in which electric power transmission is performed by determining a plurality of combinations of an output level of a first electric power transmitting apparatus and an output level of a second electric power transmitting apparatus when operating in the main electric power transmission mode, and sequentially changing a combination from among the plurality of determined combinations. That is, the compound mode performs electric power transmission from a plurality of electric power transmitting apparatuses to a plurality of electric power receiving apparatuses by dynamically controlling the output levels over the passage of time.

Hereunder, electric power transmission processing sequences in each of the individual mode, the hybrid mode, and the compound mode are described.

First, sequences in the individual mode are described. The individual mode is a mode in which point to point electric power transmission is performed between the electric power transmitting apparatus and the electric power receiving apparatus.

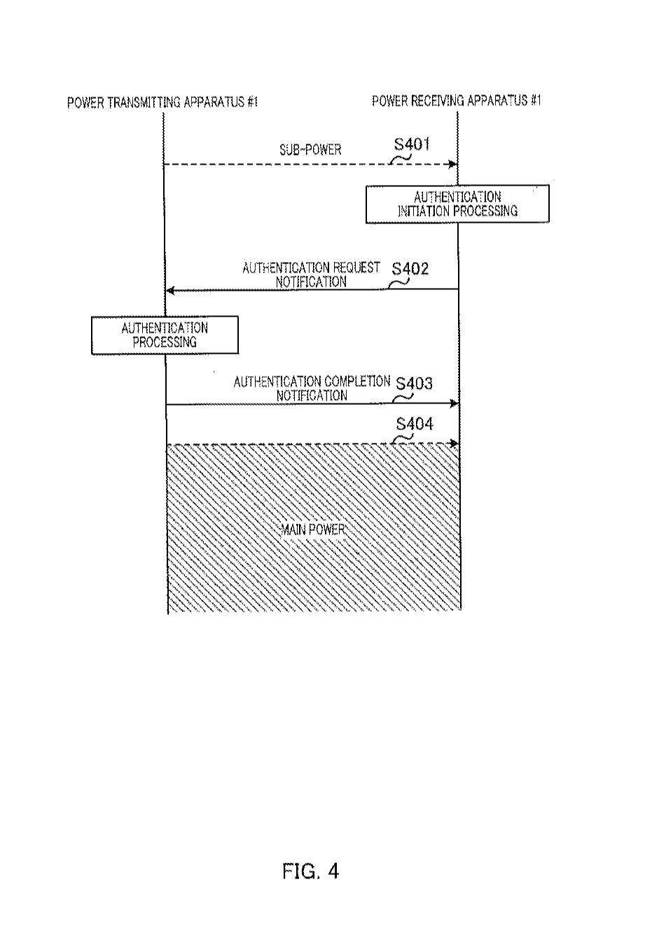

FIG. 4 illustrates an example of sequences in the individual mode. Hereunder, an example is described in which a single electric power transmitting apparatus #1 and a single electric power receiving apparatus #1 are present in the wireless electric power transmission system.

Electric power transmitting apparatus #1 repeatedly performs electric power transmission of the sub-power at random time intervals in the sub-electric power transmission mode (sequence S401).

Upon detecting electric power transmission of the sub-power from electric power transmitting apparatus #1, electric power receiving apparatus ill transmits an authentication request notification as a power request notification to electric power transmitting apparatus #1 (sequence S402).

Upon receiving the authentication request notification from electric power receiving apparatus #1, electric power transmitting apparatus #1 executes authentication processing with respect to electric power receiving apparatus #1. Upon confirming that electric power receiving apparatus #1 is a electric power receiving apparatus for which electric power transmission can be performed, electric power transmitting apparatus #1 transmits an authentication completion notification to electric power receiving apparatus #1 as a notification to the effect that the power request is accepted (sequence S403).

After transmitting the authentication completion notification, electric power transmitting apparatus #1 transitions to the main electric power transmission mode from the sub-electric power transmission mode and starts transmission of main power to electric power receiving apparatus #1 (sequence S404).

The electric power transmission is realized by electric power transmitting apparatus #1 and electric power receiving apparatus #1 executing the above described processing. Note that, as shown in FIG. 4, the sub-electric power transmission period in which electric power transmission is performed from electric power transmitting apparatus #1 in the sub-electric power transmission mode is short compared to the main electric power transmission period in which the main power is transmitted from electric power transmitting apparatus #1 in the main electric power transmission mode.

By performing the above processing, in the individual mode, reception of the sub-power that is transmitted at irregular intervals from electric power transmitting apparatus #1 in the sub-electric power transmission mode allows electric power receiving apparatus #1 to send a power request notification, even when electric power receiving apparatus #1 has no remaining power. Accordingly, electric power receiving apparatus #1 can receive power transmitted from electric power transmitting apparatus #1 that has accepted the power request, and thus can be charged.

Next, sequences in the hybrid mode are described. The hybrid mode is a mode in which electric power transmission is performed from a plurality of electric power transmitting apparatuses to a certain electric power receiving apparatus.

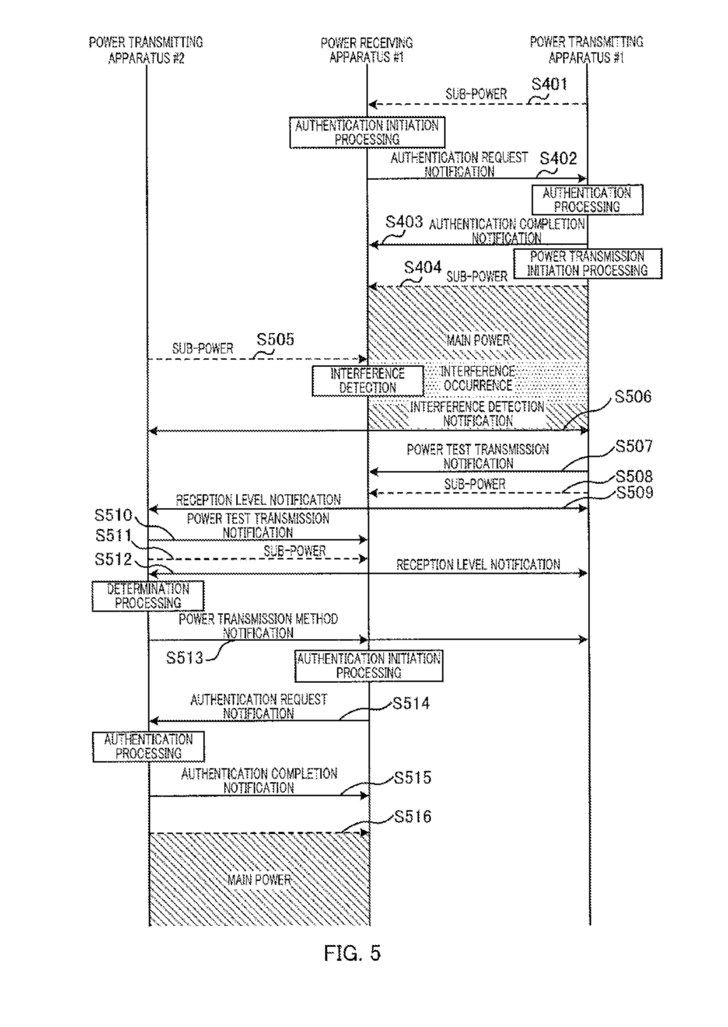

FIG. 5 illustrates an example of sequences in the hybrid mode. Note that in FIG. 5, a sequence that is the same as in FIG. 4 is denoted by the same reference symbol, and a description thereof is omitted. Hereunder, an example is described of a case where electric power transmitting apparatuses 41 and 42 and electric power receiving apparatus #1 are present in the wireless electric power transmission system.

Note that the sequences shown in FIG. 5 represent an example in a case where, in order to enable reception of transmitted power with higher efficiency at electric power receiving apparatus #1, the electric power transmitting apparatus that transmits power to electric power receiving apparatus #1 is switched from electric power transmitting apparatus #1 to electric power transmitting apparatus #2.

In this case, similarly to electric power transmitting apparatus #1 described above, electric power transmitting apparatus #2 repeatedly performs electric power transmission of the sub-power at random time intervals in the sub-electric power transmission mode (sequence S505).

It is assumed that electric power transmitting apparatus 41 that is operating in the main electric power transmission mode performs electric power transmission of the main power to electric power receiving apparatus #1. During the period that electric power transmitting apparatus #1 performs electric power transmission of the main power, if electric power transmitting apparatus #2 that is in the sub-electric power transmission mode performs electric power transmission of sub-power close to electric power receiving apparatus #1 and electric power transmitting apparatus #1, interference occurs at electric power receiving apparatus #1. As a result of the occurrence of this interference, the power that can be obtained by electric power receiving apparatus #1 changes.

Electric power receiving apparatus #1 monitors the power reception state, and upon detecting a change in the power reception state, determines that the occurrence of interference is detected. Upon detecting the occurrence of interference, electric power receiving apparatus #1 transmits an interference is detection notification to electric power transmitting apparatus ill and electric power transmitting apparatus #2 (sequence S506).

Electric power transmitting apparatus #1 and electric power transmitting apparatus #2 each having received the interference detection notification transitions to sub-electric power transmission mode, and after waiting for a random time interval, transmits a power test transmission notification to electric power receiving apparatus #1 (sequences S507 and S510). Thereafter, electric power transmitting apparatus #1 and electric power transmitting apparatus execute electric power transmission of the sub-power (test transmission of power) (sequences S508 and S511).

Electric power receiving apparatus #1 generates a reception level notification in which the reception levels with respect to the power transmitted from the respective electric power transmitting apparatuses and the IDs of the respective electric power transmitting apparatuses are associated, and transmits the reception level notification to electric power transmitting apparatus #1 and electric power transmitting apparatus #2 (sequences S509 and S512). Note that electric power receiving apparatus #1 receives the IDs of the electric power transmitting apparatuses in the respective power test transmission notifications.

Electric power transmitting apparatus #2 executes processing to determine the optimal electric power transmitting apparatus based on the reception levels with respect to the test transmission of power from each electric power transmitting apparatus, and transmits a electric power transmission, method notification showing the thus-determined electric power transmitting apparatus to electric power receiving apparatus #1 (sequence S513).

Information showing the electric power transmission method in the main electric power transmission mode and the optimal electric power transmitting apparatus is included in the electric power transmission method no the following description, it is assumed that electric power transmitting apparatus #2 is included as the information regarding the optimal electric power transmitting apparatus in the electric power transmission method notification.

In accordance with the electric power transmission method notification received from electric power transmitting apparatus #2, electric power receiving apparatus #1 transmits an authentication request notification as a power request notification to the optimal electric power transmitting apparatus #2 (sequence S514).

Upon receiving the authentication request notification from electric power receiving apparatus #1, electric power transmitting apparatus #2 executes authentication processing, and upon confirming that electric power receiving apparatus #1 is a electric power receiving apparatus for which electric power transmission can be performed, transmits an authentication completion notification to electric power receiving apparatus #1 (sequence S515).

After transmitting the authentication completion notification, electric power transmitting apparatus #2 starts electric power transmission of the main power to electric power receiving apparatus #1 (sequence S516).

By performing the above described processing, in the hybrid mode, electric power receiving apparatus #1 can receive power from the optimal electric power transmitting apparatus #2.

Note that, in a case where a electric power receiving apparatus moves in a electric power transmission range of a plurality of electric, power transmitting apparatuses also, by means of the above described procedures, it is possible for the electric power receiving apparatus to receive power from the optimal electric power transmitting apparatus.

Thus, in the hybrid mode, detection of interference at a electric power receiving apparatus acts as a trigger that switches each electric power transmitting apparatus from the main electric power transmission mode to the sub-electric power transmission mode, and the plurality of electric power transmitting apparatuses transmit the sub-power as a test transmission of power. Further, the hybrid mode determines the optimal electric power transmitting apparatus based on the reception levels with respect to the power that was transmitted as a test transmission from the plurality of electric power transmitting apparatuses. Therefore, since the optimal electric power transmitting apparatus to perform electric power transmission with respect to a certain electric power receiving apparatus is set from among a plurality of electric power transmitting apparatuses, a decline in the transmission efficiency can be avoided.

Next, sequences in the compound mode are described. The compound mode is a mode that performs electric power transmission by sequentially changing combinations from among a plurality of combinations in which output levels of a first electric power transmitting apparatus and output levels of a second electric power transmitting apparatus in the main electric power transmission mode are associated. Hereunder, an example is described of a case where electric power transmitting apparatuses #1 and #2 and electric power receiving apparatuses #1, #2, and #3 are present in the wireless electric power transmission system.

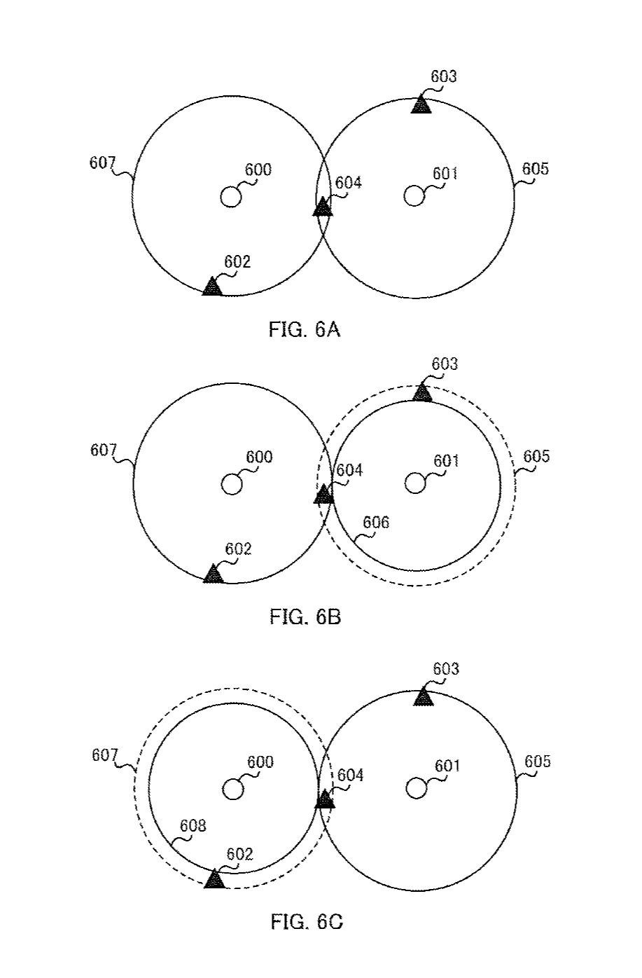

FIGS. 6A to 6C illustrate a configuration example of the wireless electric power transmission system in the compound mode.

In FIG. 6A, electric power receiving apparatus #3 (604) is disposed within a power transmittable range of both electric power transmitting apparatus #1 (600) and electric power transmitting apparatus #2 (601). Here, power transmittable range (607) shows a range in which electric power transmission from electric power transmitting apparatus #1 (600) is possible. Further, power transmittable range (605) shows a range in which electric power transmission from electric power transmitting apparatus #2 (601) is possible.

In addition, electric power receiving apparatus #1 (602) is disposed at a location that is separated from electric power transmitting apparatus #1 (600) by a distance that is substantially the same as a distance between electric power transmitting apparatus #1 (600) and electric power receiving apparatus #3 (604).

Further; electric power receiving apparatus #2 (603) is disposed at a location that is separated from electric power transmitting apparatus #2 (601) by a di stance that is substantially the same as a distance between electric power transmitting apparatus #2 (601) and electric power receiving apparatus #3 (604).

In this case, if electric power transmitting apparatus #1 (600) and electric power transmitting apparatus #2 (601) perform electric power transmission simultaneously, interference occurs at electric power receiving apparatus #3 (604) and a state arises in which it is difficult for power to be transmitted thereto.

To solve this problem, a method can be considered that limits the power of any one of electric power transmitting apparatus #1 (600) and electric power transmitting apparatus #2 (601). However, in a state in which the power of any one of electric power transmitting apparatus #1 (600) and electric power transmitting apparatus #2 (601) has been limited, electric power transmission to electric power receiving apparatus #1 (602) or electric power receiving apparatus #2 (603) will stop.

Therefore, in the compound mode, for example, by, alternately repeating the states indicated by the solid lines in FIG. 6B and FIG. 6C, electric power transmission of the main power to all of electric power receiving apparatuses #1 (602), #2 (603), and #3 (604) is realized intermittently. Note that, in FIG. 6B, power transmittable range (606) shows a range in which electric power transmission from electric power transmitting apparatus #2 (601) is possible after a change in the output level, In comparison to power transmittable range (605), power transmittable range (606) is a smaller power transmittable range. Further, in FIG. 6C, power transmittable range (608) shows a range in which electric power transmission from electric power transmitting apparatus #1 (600) is possible after a change in the output level. In comparison to power transmittable range (607), power transmittable range (608) is a smaller power transmittable range.

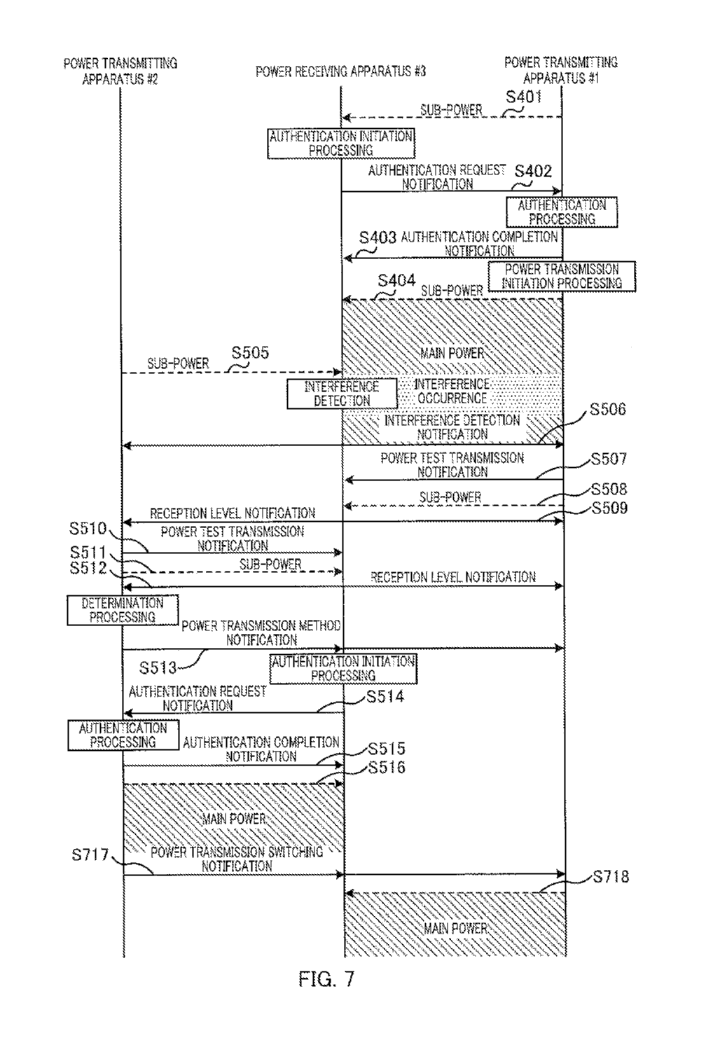

FIG. 7 shows an example of sequences in the compound mode. Note that a description of electric power receiving apparatus #1 (602) and electric power receiving apparatus #2 (603) is omitted in FIG. 7. Further, in FIG. 7, sequences that are the same as sequences in FIG. 4 and FIG. 5 are denoted by the same reference symbol, and a description thereof is omitted.

After the completion of sequence S512, electric power transmitting apparatus #2 determines the optimal combination of electric power transmitting apparatuses and output levels based on the reception levels with respect to the sub-power (test transmission of power) from the respective electric power transmitting apparatuses.

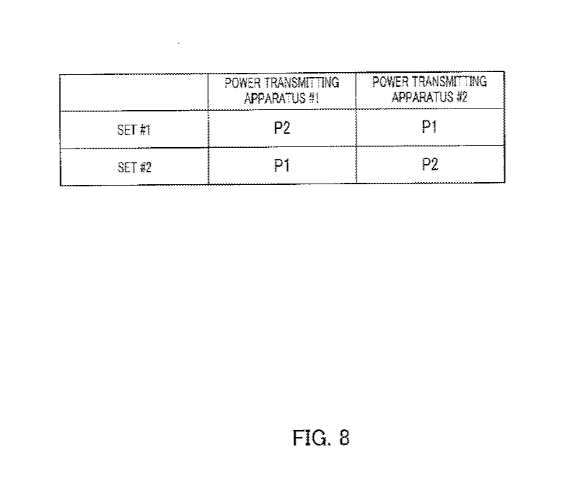

FIG. 8 illustrates an example of combinations of optimal electric power transmitting apparatuses and output levels. FIG. 8 illustrates an example in which electric power transmitting apparatuses #1 and #2 have been determined as the optimal electric power transmitting apparatuses and two pairs (sets #1 and #2) of the output levels of electric power transmitting apparatuses #1 and #2 have been determined. P1 represents an output level that is realized in power transmittable ranges (605 and 607). P2 represents an output level that is realized in power transmittable ranges (606 and 608).

Electric power transmitting apparatus #2 transmits a electric power transmission method notification showing the determined electric power transmitting apparatuses to electric power receiving apparatus #3 (sequence S513). At this time, electric power transmitting apparatus #2 transmits a electric power transmission method notification indicating two or more electric power transmitting apparatuses to electric power receiving apparatus #3.

When a electric power transmitting apparatus notification indicates two or more electric power transmitting apparatuses, electric power receiving apparatus #3 receives power transmitted from two or more electric power transmitting apparatuses as shown in FIG. 6B and FIG. 6C. Specifically, in a first period that is a main electric power transmission period, as shown in FIG. 6B, electric power receiving apparatus #3 receives power that is transmitted from electric power transmitting apparatus #1 (600). On the other hand, in a second period that is a main electric power transmission period that is different from the first period, as shown in FIG. 6C, electric power receiving apparatus #3 receives power that is transmitted from electric power transmitting apparatus #2 (601).

Therefore, when electric power transmitting apparatus #1 and electric power transmitting apparatus #2 are notified as the electric power transmitting apparatuses in sequence S513, electric power receiving apparatus #3 transmits an authentication request notification to electric power transmitting apparatus #2 from which authentication has not been acquired (sequence S514).

Electric power transmitting apparatus #2 transmits an authentication completion notification to electric power receiving apparatus #3 (sequence S515).

Thereafter, electric power transmitting apparatus #2 starts electric power transmission of the main power to electric power receiving apparatus #3 (sequence S516).

Subsequently, after a certain time period, electric power transmitting apparatus #2 transmits a electric power transmission switching notification to electric power receiving apparatus #3 and electric power transmitting apparatus (sequence S717).

Upon receiving the electric power transmission switching notification, electric power transmitting apparatus #1 starts electric power transmission of the main power to electric power receiving apparatus #3 (sequence S718).

Thereafter, according to the present embodiment, sequences S717 and S718 are repeated so that electric power transmitting apparatus #1 and electric power transmitting apparatus #2 alternatively perform electric power transmission of the main power to electric power receiving apparatus #3.

By performing the above processing, the compound mode determines a plurality of combinations of an output level of the first electric power transmitting apparatus and an output level of the second electric power transmitting apparatus in the main electric power transmission mode, and performs electric power transmission by sequentially changing a combination from among the plurality of determined combinations. As a result, the compound mode can perform electric power transmission while avoiding interference even when there are a plurality of electric power receiving apparatuses.

The wireless electric power transmission system according to the related art is inefficient, the system transmitting power by performing time division control for an entire system in which a plurality of electric power transmitting apparatuses and electric power receiving apparatuses utilize mainly the same frequency as a electric power transmission frequency. This is because, when there are a plurality of electric power transmitting apparatuses and electric power receiving apparatuses, time division control is performed even for a electric, power receiving apparatus that does not cause interference. In contrast, the compound mode of the present embodiment can transmit power to a plurality of electric power receiving apparatuses within a wireless electric power transmission system while avoiding a decline in efficiency.

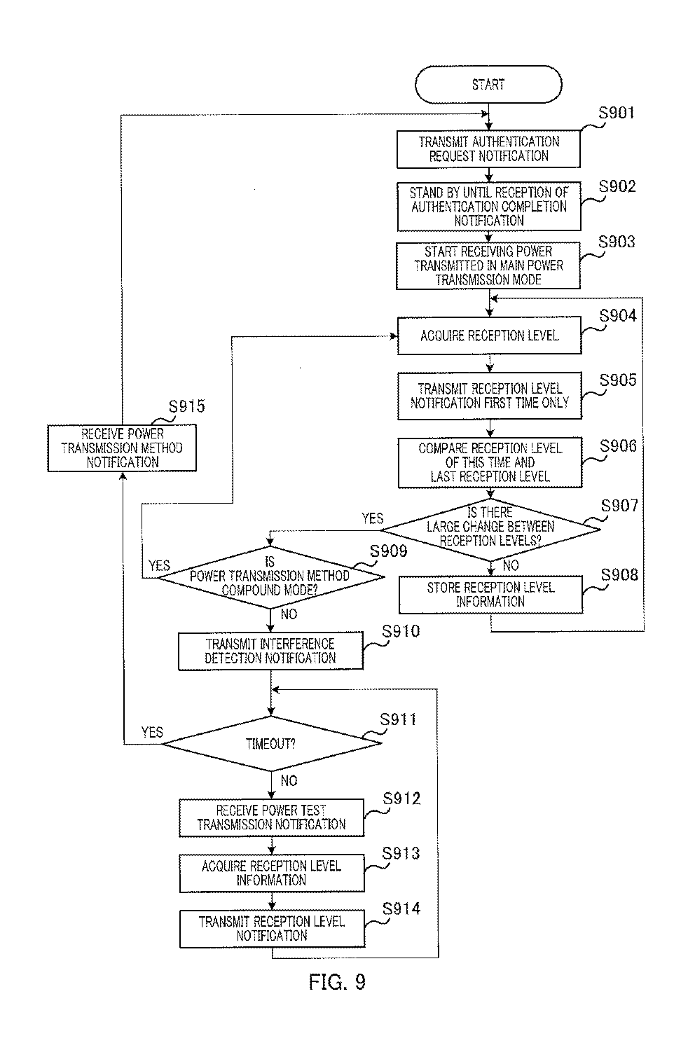

FIG. 9 to FIGS. 11A and 11B are flowcharts that illustrate processing performed by a electric power receiving apparatus and electric power transmitting apparatus that implement the above described sequences.

FIG. 9 is a flowchart that illustrates processing of electric power receiving apparatus 200.

The processing starts from a point at which power receiving section 211 receives power transmitted at irregular intervals from a electric power transmitting apparatus in the sub-electric power transmission mode.

Control section 222 transmits an authentication request notification as a power request notification to the electric power transmitting apparatus (step S901). Specifically, control section 222 requests device authentication section 223 to issue an authentication request, and communication section 224 transmits an authentication request notification to the electric power transmitting apparatus.

Control section 222 stands by until an authentication completion notification is received (step S902).

Thereafter, control section 222 receives an authentication completion, notification from, the electric power transmitting apparatus, and starts receiving power transmitted in the main electric power transmission mode (step S903).

Control section 222 acquires the reception state (reception level of the received power) from reception level determining section 221 (step S904).

Control section 222 transmits information showing the reception level as a reception level notification to the electric power transmitting apparatus only when the reception level is acquired the first time (step S905). Specifically, control section 222 requests communication section 224 to transmit information showing the reception level. Communication section 224 transmits the information showing the reception level to the electric power transmitting apparatus as a reception level notification.

Control section 222 compares the reception level acquired the last time with the reception level newly acquired this time (step S906). If there is no significant change between the last reception level and the current reception level (step S907: No), control section 222 stores the information of the current reception level for use in the next comparison (step S908).

In contrast, if there is a significant change between the last reception level and the current reception level (step S907: Yes), control section 222 executes the processing in step S909 if the electric power transmission method notified by the electric power transmitting apparatus is the compound mode (step S909: Yes), control section 222 determines that the electric power transmitting apparatus has been switched and shifts the processing to step S904. In contrast, if the electric power transmission method is not the compound mode (step S909: No), control section 222 determines that interference has occurred or that the surrounding environment has changed, and transmits an interference detection notification to the electric power transmitting apparatus (step S910). Specifically, control section 222 requests communication section 224 to transmit an interference detection notification, and communication section 224 transmits the interference detection notification to the electric power transmitting apparatus.

Control Section 222 receives a power test transmission notification from each electric power transmitting apparatus (step S912) within a prescribed timeout period (step S911: No). Control section 222 acquires information showing the reception level from reception level determining section 221 with respect to each power test transmission notification that is received (step S913), Control section 222 transmits the reception level information as a reception level notification to the electric power transmitting apparatuses (step S914). Specifically, control section 222 requests communication section 224 to transmit the reception level information, and communication section 224 transmits the reception level information as a reception level notification to the electric power transmitting apparatuses.

After the timeout period (step S911: Yes), control section 222 receives a electric, power transmission method notification showing from which electric power transmitting apparatus power is to be transmitted from next from a electric power transmitting apparatus (step S915).

Based on the contents of the electric power transmission method notification, control section 222 transmits an authentication request notification to the electric power transmitting apparatus that is to perform electric power transmission (step S901).

Thereafter, control section 222 repeats the processing in steps S901 to S915.

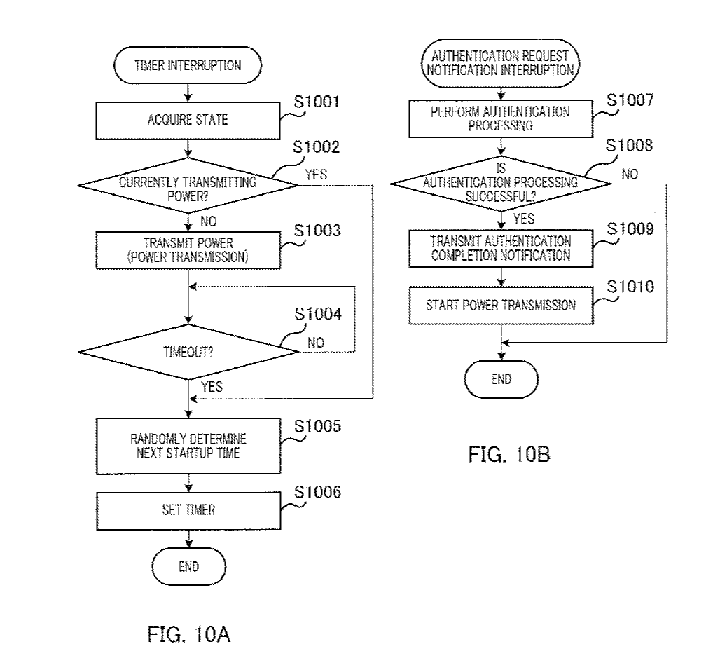

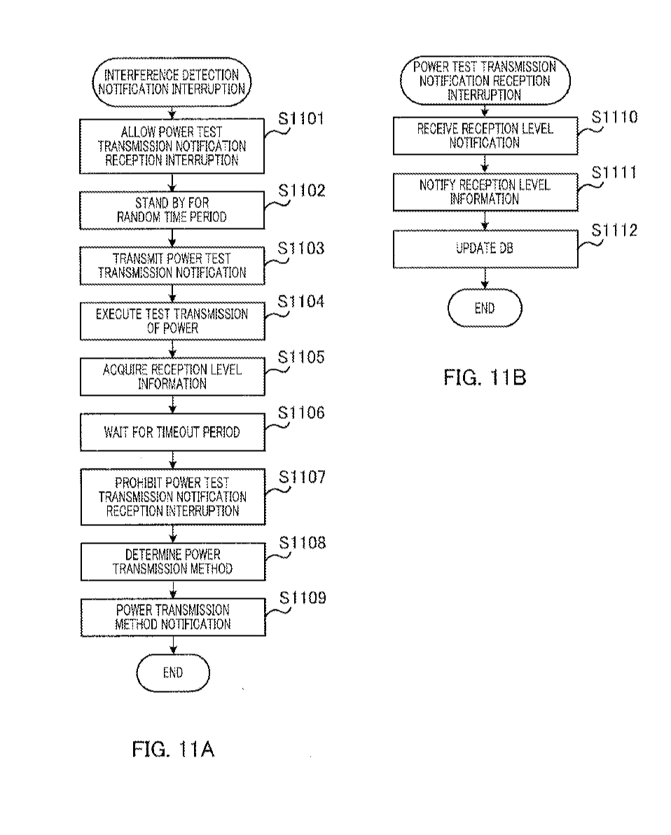

Next, processing performed by a electric power transmitting apparatus is described. FIGS. 10A and 10B and FIGS. 11A and 11B are flowcharts that illustrate processing performed by a electric power transmitting apparatus.

FIG. 10A is a flowchart illustrating processing performed by a electric power transmitting apparatus that transmits sub-power at random time intervals in the sub-electric power transmission mode (irregular electric power transmission).

Electric power transmission control section 320 starts the processing by timer interruption set at the previous startup time.

Electric power transmission control section 320 acquires the present electric power transmission state (step S1001), and confirms whether or not the electric power transmitting apparatus including electric power transmission control section 320 is in the process of transmitting power (step S1002).

if the electric power transmitting apparatus is not in the process of transmitting power (step S1002: No), electric power transmission control section 320 executes step S1003. In contrast, if the electric power transmitting apparatus is in the process of transmitting power (step S1002: Yes), electric power transmission control section 320 executes step S1005.

Electric power transmission control section 320 instructs power transmitting section 310 to transmit the sub-power, and power transmitting section 310 executes transmission of the sub-power (step S1003).

If electric power transmission control section 320 executes electric power transmission with respect to the electric power receiving apparatus in step S1003, electric power transmission control section 320 waits for a certain timeout period in order to receive an authentication request notification as a power request notification from the electric power receiving apparatus (step S1004).

After the timeout period elapses (step S1004: Yes), electric power transmission control section 320 randomly determines the next startup time (step S1005).

Electric power transmission control section 320 sets the next startup time in the timer (step S1006).

By repeating the processing in steps S1001 to S1006, electric power transmitting apparatus performs transmission of the sub-power (irregular electric power transmission) at random time intervals.

FIG. 10B is a flowchart that illustrates processing of a electric power transmitting apparatus in a case where the electric power receiving apparatus transmits an authentication request notification as a power request notification to the electric power transmitting apparatus.

Upon receiving an authentication request notification from the electric, power receiving apparatus, device authentication section 340 executes authentication processing for determining whether electric power transmission is possible, based on information included in the authentication request notification (step S1007).

If the authentication processing performed by device authentication section 340 fails (step S1008: No), the transmitting apparatus ends the processing. In contrast, if the authentication processing performed by device authentication section 340 succeeds (step S1008: Yes), the transmitting apparatus executes step S1009.

The communication section 350 transmits an authentication completion notification to the electric power receiving apparatus (step S1009).

Electric power transmission control section 320 instructs power transmitting section 310 to start transmitting power, and power transmitting section 310 starts transmitting power to the electric power receiving apparatus (step S1010).

By performing the processing of steps S1007 to S1010, the electric power transmitting apparatus transmits an authentication completion notification to the elect c power receiving apparatus and starts transmitting power thereto.

FIG. 11A is a flowchart: that illustrates processing of the electric power transmitting apparatus in the case of receiving an interference detection notification transmitted from a electric power receiving apparatus.

In order to acquire information showing the reception level between each electric power transmitting apparatus and the electric power receiving apparatus, the electric power transmitting apparatus allows a power transmission notification reception interruption (step S1101). The electric power transmitting apparatus thereby shifts to the sub-electric power transmission mode.

Electric power transmission control section 320 stands by for a random time period so that a timing for performing power test transmission does not overlap with that of another electric power transmitting apparatus (step S1102).

After the random time period elapses, communication section 350 transmits a power test transmission notification (step S1103).

Power transmitting section 310 transmits the sub-power (test transmission of power) (step S1104).

Communication section 350 acquires information showing a reception level from the electric power receiving apparatus (step S1105).

The electric power transmitting apparatus waits until a certain timeout period elapses (step S1106), and thereafter prohibits a power test transmission notification reception interruption (step S1107). The electric power transmitting apparatus thereby shifts to the main electric power transmission mode.

Determination section 330 determines a electric power transmission method for the electric power receiving apparatus (step S1108).

Communication section 350 transmits a electric power transmission method notification that shows information indicating the determined electric power transmission method to the electric power receiving apparatus (step S1109).

By performing the processing in steps S1101 to S1109, the electric power transmitting apparatus determines the electric power transmission method for the electric power receiving apparatus.

FIG. 11B is a flowchart that illustrates processing of the electric power transmitting apparatus in the case of receiving reception information with respect to a power test transmission from another electric power transmitting apparatus.

Device interrelationship judgment section 331 receives the reception level notification and acquires information showing the reception level (step S1110). In this case, the reception level information is information to be transmitted by the electric power receiving apparatus as a response after receiving a power test transmission notification sent by another electric power transmitting apparatus.

Device interrelationship judgment section 331 notifies the acquired reception level information to electric power receiving apparatus management section 332 (step S1111), and also updates a database (DB) (step S1112).

By performing the series of processing in steps S1110 to S1112, electric power transmitting apparatus acquires information regarding a reception level between another electric power transmitting apparatus and the electric power receiving apparatus.

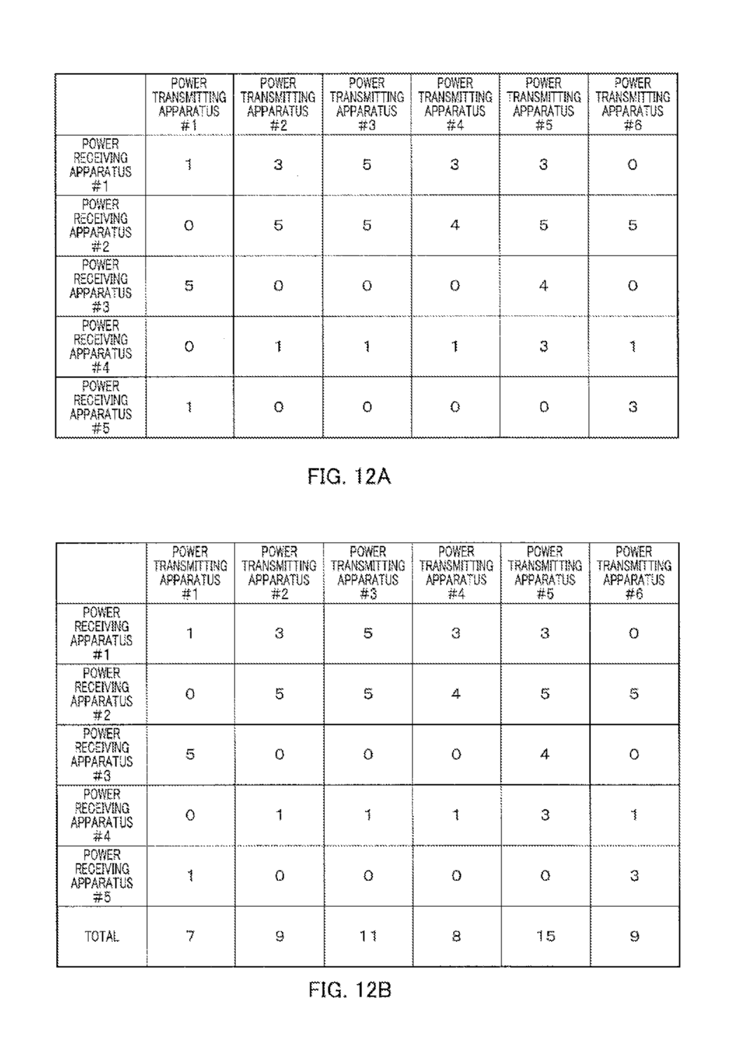

Next, a method of determining a electric power transmission method in the compound mode is described using FIGS. 12A and 12B, FIG. 13 and FIG. 14.

FIG. 12A is a diagram illustrating an example of an information table recorded by electric power receiving apparatus management section 332 of electric power transmitting apparatus 300. Note that, FIG. 12A illustrates an example in which electric power receiving apparatus management section 332 records reception levels between electric power receiving apparatuses #1, #2, #3, #4, and #5 and electric power transmitting apparatuses #1, #2, #3, #4, #5, and #6 as a table. In the table, numbers “0 to 5” represent reception levels. A higher that the value among the six reception levels “0 to 5” is, the higher the level of reception that is indicated thereby. For example, at electric power receiving apparatus #1, the reception level from electric power transmitting apparatus #1 is “1.”

Next, a method of determining a electric power transmission method used by determination section 330 in the compound mode is described.

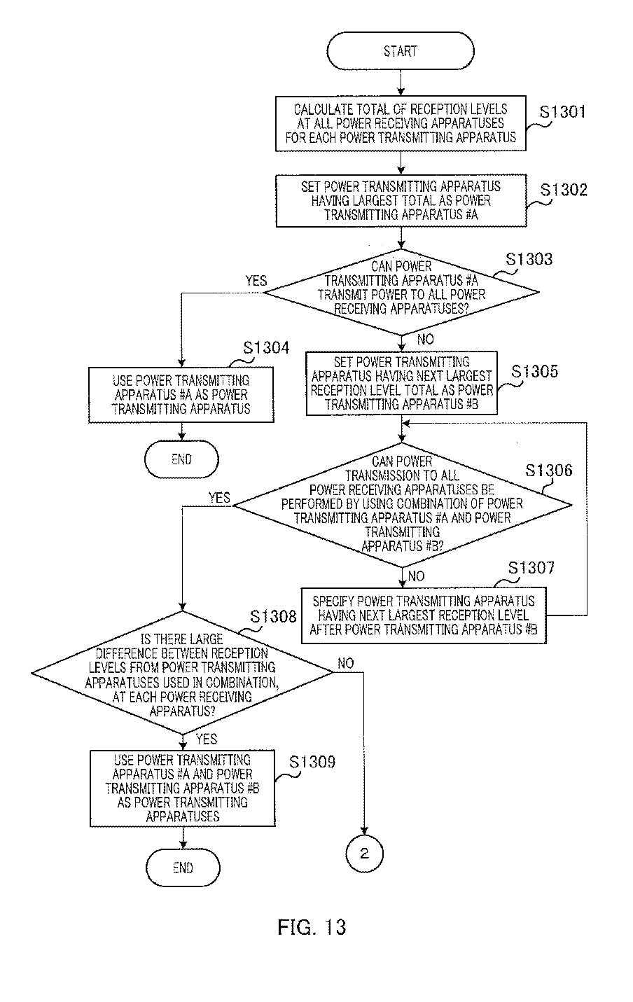

FIG. 13 is a flowchart for describing the method of determining the electric power transmission method.

Each of the electric power transmitting apparatuses determines a total of the reception levels of all the electric power receiving apparatuses for the electric power transmitting apparatus (step S1301). FIG. 12B is an example in which, the totals of the reception levels for the respective electric power transmitting apparatuses with respect to the table shown in FIG. 12A are additionally described. For example, in FIG. 12A, in the total of electric transmitting apparatus #1 is a total value of the reception levels at which the respective electric power receiving apparatuses received power transmitted from electric power transmitting apparatus #1.

Determination section 330 sets the electric power transmitting apparatus having the largest total reception level as electric power transmitting apparatus #A (step S1302).

In the example shown in FIG. 12B, the electric poorer transmitting apparatus having the largest total value of the reception levels is electric power transmitting apparatus #5. Accordingly, in this case, determination section 330 sets electric power transmitting apparatus 115 as electric power transmitting apparatus #A.

Next, determination section 330 checks whether electric power transmitting apparatus #A can transmit power to all the electric power receiving apparatuses. In order to cheek whether electric power transmitting apparatus #A is capable of transmitting power to all the electric power receiving apparatuses, for example, determination section 330 can check whether the reception level of all the electric power receiving apparatuses with respect to power transmitted from electric power transmitting apparatus #A is at least “1” in FIG. 12A.

If electric power transmission to all the electric power receiving apparatuses is possible (step S1303: Yes), determination section 330 executes step S1304. In contrast, if power cannot be transmitted to all the electric power receiving apparatuses (step S1303: No), determination section 330 executes step S1305.

In step S1304, determination section 330 determines that only electric power transmitting apparatus #A is to be used.

In step S1305, determination section 330 refers to the total values of the reception levels obtained in step S1301, and sets a electric power transmitting apparatus having the second largest total value of the reception levels after electric power transmitting apparatus VA as electric power transmitting apparatus #B (step S1305).

Subsequently, in step S1306, determination section 330 checks whether electric power transmission to all the electric power receiving apparatuses is possible by the combination of electric power transmitting apparatus #A and electric power transmitting apparatus #B. If electric power transmission to all the electric power receiving apparatuses is not possible (step S1306: No), determination section 330 proceeds to step S1.307. Determination section 330 refers to the total values obtained in step S1301, and newly sets the electric power transmitting apparatus having the third largest total reception level after electric power transmitting apparatus #B as electric power transmitting apparatus #B (step S1307).

In contrast, if electric power transmission to all the electric power receiving apparatuses is possible (step S1306; Yes), determination section 330 executes step S1308.

In the example shown in FIG. 12B, electric power transmitting apparatus #5 corresponds to electric power transmitting apparatus #A, and electric power transmitting apparatus #3 having the second largest total value of the reception levels after electric power transmitting apparatus #A corresponds to electric power transmitting apparatus #B. However, the reception level with respect to electric power receiving apparatus #5 of power transmitted from both electric power transmitting apparatus #5 and electric power transmitting apparatus #3 is “0.” Therefore, electric power transmission to electric power receiving apparatus #5 cannot be performed by the combination of electric power transmitting apparatus #5 and electric power transmitting apparatus #3.

In a case like this in which electric power transmission to all the electric power receiving apparatuses cannot be performed by the combination of electric power transmitting apparatus #5 and electric power transmitting apparatus #3, determination section 330 sets electric power transmitting apparatus #2 or electric power transmitting apparatus #6 having the third largest total value of the reception levels after electric power transmitting apparatus #3 as electric power transmitting apparatus #B. However, the combination of electric power transmitting apparatus #5 and electric power transmitting apparatus #2 cannot perform electric power transmission to electric power receiving apparatus #5. In contrast, the combination of electric power transmitting apparatus #5 and electric power transmitting apparatus #6 can perform electric power transmission to all the electric, power receiving apparatuses. Therefore, determination section 330 sets electric power transmitting apparatus #6 as electric power transmitting apparatus #B.

By repeating this processing, determination section 330 determines a electric power transmitting apparatus that can perform electric power transmission to all the electric power receiving apparatuses when combined with electric power transmitting apparatus #5 having the largest total value of the reception levels.

Subsequently, in step S1308, determination section 330 confirms whether or not interference occurs when electric power transmission is executed from both electric power transmitting apparatus #A and electric power transmitting apparatus #B. For example, determination section 330 utilizes the table shown in FIG. 12B to confirm whether or not interference occurs. When electric power transmitting apparatuses #A and #B are electric power transmitting apparatuses #5 and #6, the reception levels for each of the electric power receiving apparatuses in the columns for electric power transmitting apparatus #5 and electric power transmitting apparatus #6 in the table of FIG. 12B are compared in the present embodiment. That is for each of the electric power receiving apparatuses, determination section 330 confirms whether or not there is a large difference between the reception levels of received power transmitted from electric power transmitting apparatuses #A and #B used in combination. Subsequently, determination section 330 checks whether or not interference occurs by checking whether or not the reception levels differ significantly. Specifically, if the reception levels do not differ significantly, determination section 330 determines that interference occurs, and if the reception levels differ significantly, determination section 330 determines that interference does not occur.

If the reception levels differ significantly (step S1308: Yes), that is, if determination section 330 determines that interference does not occur, determination section 330 decides to utilize electric power transmitting apparatus #A and electric power transmitting apparatus #B without any change (step S1309).

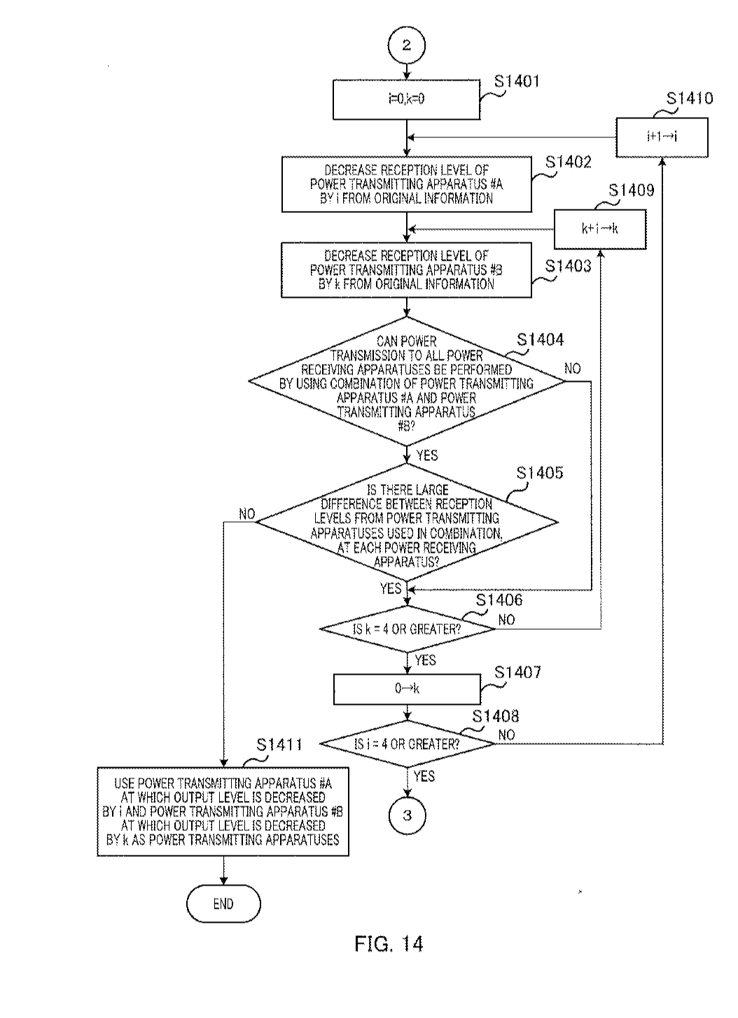

In contrast, if the reception levels do not differ significantly (step S1308: No), that is, if determination section 330 determines that interference occurs, determination section 330 transitions to flow “2” shown in FIG. 14. Flow “2” adjusts the output levels of electric power transmitting apparatus #A and electric power transmitting apparatus #B.

In the example shown in FIG. 12B, at electric power receiving apparatus #2, the reception levels of received power transmitted from electric, power transmitting apparatuses 45 and #6 are the same level, and thus the reception levels do not differ significantly (step S1308: No). Consequently, in this case, determination section 330 transitions to flow “2” shown in FIG. 14. Flow “2” is a flow of a method for adjusting the output levels of electric power transmitting apparatuses #A and #B.

FIG. 14 is a flowchart for describing a method of adjusting the output levels of electric power transmitting apparatuses #A and #B. Determination section 330 determines whether or not electric power transmitting apparatus #A and electric power transmitting apparatus #B can be utilized at the same time by lowering the output level of electric power transmission, of the two electric power transmitting apparatuses #A and #B.

In steps S1401 to S1410, while reducing the reception levels of the respective electric power receiving apparatuses by amounts “i” and “k,” determination section 330 makes a determination in steps S1404 and S1405 with respect to each state. By executing these steps, determination section 330 assumes a ease where the electric power transmission output levels of the electric power transmitting apparatuses are lowered.

Subsequently, based on the reception levels of each electric power receiving apparatus after adjustment, determination section 330 determines whether or not electric power transmission is possible to all, the electric power receiving apparatuses. Specifically, determination section 330 cheeks if the level “0” exists as a reception level for the electric power receiving apparatuses after adjustment, and if there is no “0” level, determination section 330 determines that it is possible to perform electric power transmission to all the electric power receiving apparatuses (step S1404: Yes) electric power transmission to all the electric power receiving apparatuses is possible (step S1404: Yes), determination section 330 executes step S1405. In contrast, if electric power transmission to all the electric power receiving apparatuses is not possible (step S1404: No), determination section 330 further lowers the reception levels of the respective electric power receiving apparatuses in steps S1406 to S1410, and returns to step S1401.

For each electric power receiving apparatus, determination section 330 determines whether or not there is a large difference between the reception levels of power received from electric power transmitting apparatus #A and electric power transmitting apparatus #B (step S1405). That is, determination section 330 checks whether electric power transmission from the electric power transmitting apparatuses results in interference at the assumed reception levels of the electric power receiving apparatuses (step S1405).

If determination section 330 determines that the reception levels are different and interference does not occur (step S1405: No), determination section 330 decides to utilize electric power transmitting apparatus #A and electric power transmitting apparatus #B at the assumed output levels as the electric power transmitting apparatuses (step S1411).

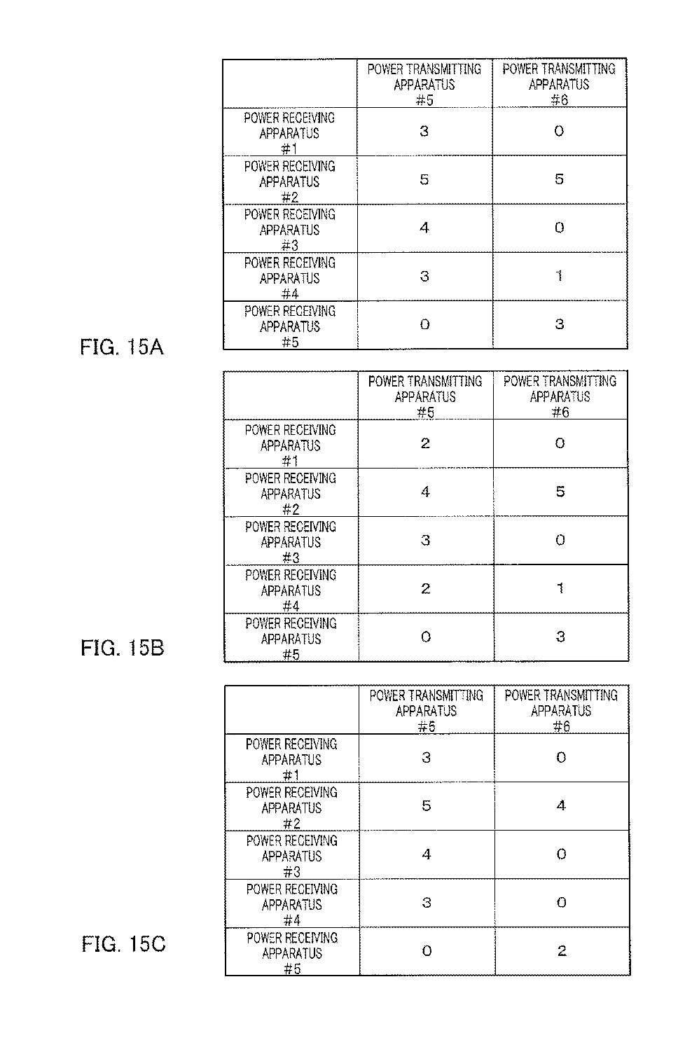

For example, FIG. 15B illustrates a state in which the levels of electric power transmitting apparatus #5 shown in FIG. 15A have been lowered by “1”. In this case, the condition “electric power transmission to all electric power receiving apparatuses is possible” that is the subject of the determination that is made in step S1404 is satisfied. However, at electric power receiving apparatus #2, there is not a large difference between the reception levels of power from the two electric power transmitting apparatuses, and hence the condition “reception levels of power from the electric power transmitting apparatuses used in combination are different at each electric power receiving apparatus” that is the subject of the determination to be made in step S1405 is not satisfied, and there is thus a possibility that interference will occur. Therefore, the state shown in FIG. 15B does not satisfy the above two conditions.

The state shown in FIG. 15C is a state for which an assumption is made that the output levels of electric power transmitting apparatus #6 are lowered by “1.” In this case, although the condition that is the subject of the determination to be made in step S1404 is satisfied, the condition that is the subject of the determination to be made in step S1405 is not satisfied.

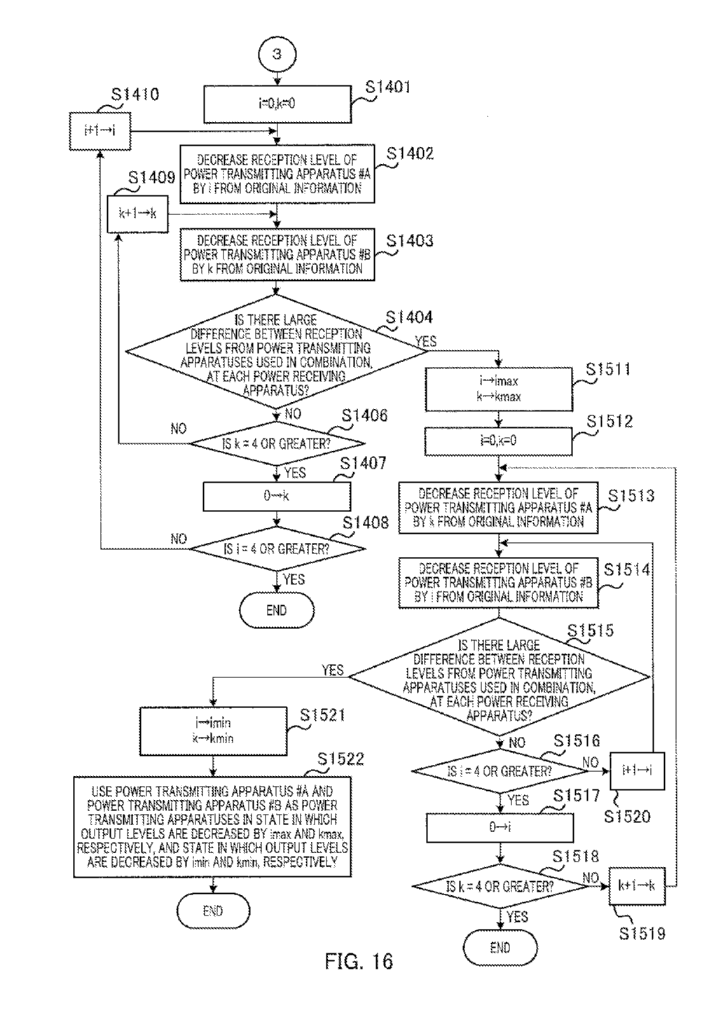

Therefore, with respect to the combination of electric power transmitting apparatuses #5 and #6, it can be determined that no matter which way the output levels of the two electric power transmitting apparatuses are adjusted, it is difficult to execute electric power transmission to all the electric power receiving apparatuses while preventing interference. If the condition that is the subject of the determination that is made in step S1405 is not satisfied (step S1408: Yes) even in a ease where the output levels of electric power transmitting apparatuses #5 and #6 are lowered as much as possible in this manner, the present embodiment transitions to flow “3” in FIG. 16. Flow “3” is a flow that executes output adjustment processing.

FIG. 16 is a flowchart illustrating output adjustment processing of a electric power transmitting apparatus in the compound mode. In FIG. 16, sequences that are the same as sequences in FIG. 14 are denoted by the same reference symbols, and a description thereof is omitted below. Determination section 330 sequentially changes a combination from among a plurality of combinations in which output levels of electric power transmitting apparatus #A and output levels of electric power transmitting apparatus #B are associated, for example as shown in FIG. 8, to perform electric power transmission.

That is, FIG. 16 is a flowchart showing processing performed by determination section 330 of each of the electric power transmitting apparatuses to determine to what degree to lower the output level to enable electric power transmission while preventing interference in order to realize, the states illustrated in FIG. 6B and FIG. 6C.

Similarly to the processing shown in FIG. 14, determination section 330 assumes a state in which a electric power transmitting apparatus lowers an output level thereof, and determines a level at which interference does not occur in the assumed state.

In steps S1401 to S1410, determination section 330 first determines the output levels of each electric power transmitting apparatus at which interference does not occur in a case where the output level of electric power transmitting apparatus #B (electric power transmitting apparatus #6) is reduced. In contrast, in steps S1511 to S1522, determination section 330 determines the output levels of each electric power transmitting apparatus at which interference does not occur in a case where the output level of electric power transmitting apparatus #A (electric power transmitting apparatus #5) is reduced.

Specifically, determination section 330 assumes a case where the output level of electric power transmitting apparatus #5 as one of the electric power transmitting apparatuses is lowered, and searches for a value with respect to which a large difference exists between the reception levels at the respective electric power receiving apparatuses even if electric power transmitting apparatus #5 and electric power transmitting apparatus #6 output power simultaneously. For example, with respect to FIG. 15A, by lowering the output level of electric power transmitting apparatus #5 by “3” without lowering the output level of electric power transmitting apparatus #6, interference between electric power transmitting apparatus #5 and electric power transmitting apparatus #6 is mostly eliminated.

Next, determination section 330 assumes a case where the output level of electric power transmitting apparatus #6 as the other electric power transmitting apparatus is lowered, and searches for a value with respect to which a large difference exists between the reception levels at the respective electric power receiving apparatuses even if electric power transmitting apparatus #5 and electric power transmitting apparatus #6 output power simultaneously. For example, with respect to FIG. 15A, by lowering the output level of electric power transmitting apparatus #6 by “3” without lowering the output level of electric power transmitting apparatus #5, interference between electric power transmitting apparatus #5 and electric power transmitting apparatus #6 is mostly eliminated.

That is, in steps S1401 to S1410, determination section 330 determines an output level of electric power transmitting apparatus #B at which interference does not occur in a case where the output level of electric power transmitting apparatus #A is used without being lowered. In contrast, in steps S1511 to S1520, determination section 330 determines an output level of electric power transmitting apparatus #A at which interference does not occur in a case where the output level of electric power transmitting apparatus #B is used without being lowered. Subsequently, in steps S1521 and S1522, determination section 330 determines a plurality of combinations of the output levels of electric power transmitting apparatus #A and electric power transmitting apparatus #B which can avoid the occurrence of interference.

Thus, transmission of power without interference from the electric power transmitting apparatuses to all electric power receiving apparatuses is enabled by, in the compound mode, alternately switching the output levels of the electric power transmitting apparatuses of the plurality of combinations and repeating electric power transmission.

Thus, the present embodiment derives a state in which the output level of electric power transmitting apparatus #6 is lowered by “3” without lowering the output level of electric power transmitting apparatus #5, and a state in which the output level of electric power transmitting apparatus #5 is lowered by “3” without lowering the output level of electric power transmitting apparatus #6. Further, according to the present embodiment, in the compound mode, by alternately creating states of these pairs of output levels, it is possible to perform electric power transmission to all the electric power receiving apparatuses without interference.

Next, information exchanged in each information communication is described.

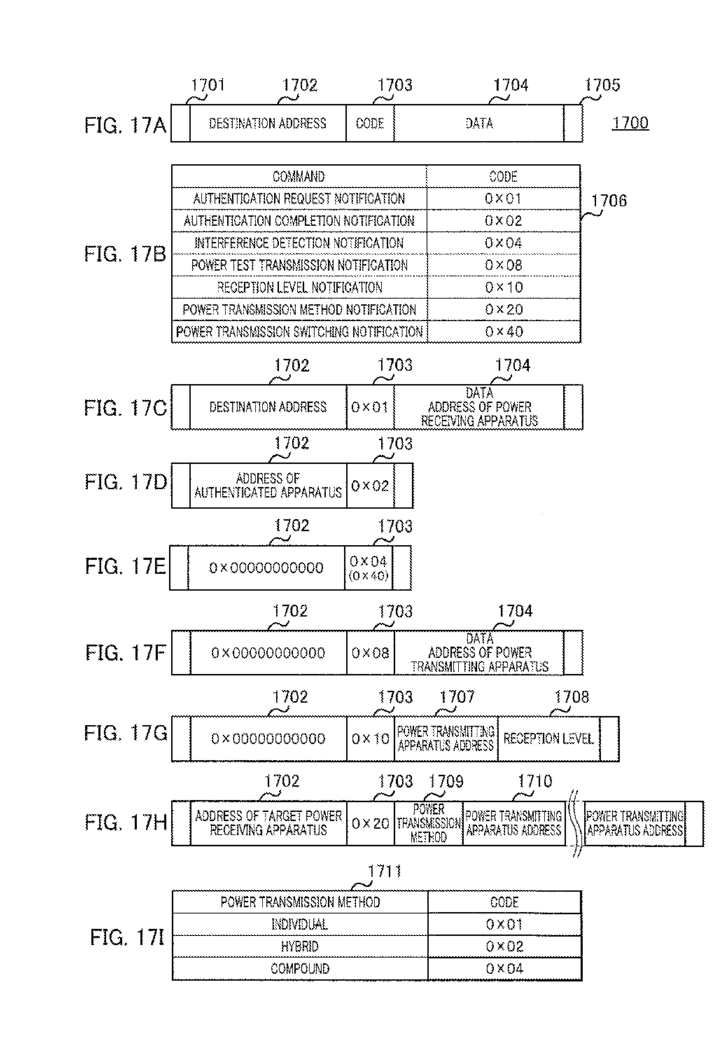

FIG. 17A shows the configuration of packet 1700 that is exchanged in an information communication.

Packet 1700 includes, from the start thereof, start code 1701, destination address 1702, code 1703, data 1704, and stop code 1705.

Start code 1701 is a specific code, and indicates the top of the packet. By detecting start code 1701, communication sections 224 and 350 detect that a packet has been received.

Destination address 1702 stores an address that identifies a device that is the transmission target of the packet. When transmitting by broadcasting rather than transmitting to a specific device, the destination address is filled with zeros.

Code 1703 shows the kind (purpose) of the instruction of each communication. FIG. 17B shows a correspondence between the kinds of communication instructions and codes. Code 1706 of FIG. 17B is described in code 1703.

Data 1704 is the content that is transmitted by the packet. It is assumed that data 1704 is of variable length.

Stop code 1705 is a specific code, and indicates the end of packet 1700.

FIG. 17C to FIG. 17H illustrate an internal configuration example of packet 1700 of each information communication. The basic configuration of packet 1700 is as described above, and differences from the basic configuration are as described below.

FIG. 17C is a configuration example of a packet used for information communication when transmitting an authentication request notification. In this ease, code 1703 is 0x01.

If the electric power receiving apparatus is broadcasting, destination address 1702 is filled with zeros. If the electric power receiving apparatus transmits to a specific electric power transmitting apparatus, the address of the electric power transmitting apparatus is assigned as destination address 1702, and the address of the electric power receiving apparatus is stored in data 1704 and transmitted.

FIG. 17D is a configuration example of a packet used for information communication when transmitting an authentication completion notification. In this case, code 1703 is 0x02.

The electric power transmitting apparatus assigns the address of the authenticated electric power receiving apparatus as destination address 1702, and transmits the packet without assigning any information to data 1704.

FIG. 17E is a configuration example of a packet used for information communication when transmitting an interference detection notification or a electric power transmission switching notification. In this case, code 1703 is 0x04 or 0x40.

Since the electric power receiving apparatus transmits the interference detection notification by broadcasting, the electric power receiving apparatus stores zeros in destination address 1702 and transmits the packet without assigning any information to data 1704.

FIG. 17F is a configuration example of a packet used for information communication when transmitting a power test transmission notification. In this case, code 1703 is 0x08.

After waiting for a random time interval after receiving an interference detection notification, the electric power transmitting apparatus transmits the power test transmission notification and thereafter performs electric power transmission for a certain time period. Note that, since the electric power transmitting apparatus transmits the power test transmission notification by broadcasting, the electric power transmitting apparatus stores zeros in destination address 1702 and stores the address of the electric power transmitting apparatus in data 1704 and transmits the packet.

FIG. 17G is a configuration example of a packet used for information communication when transmitting a reception level notification. In this case, code 1703 is 0x10.

After transmitting an interference detection notification to a electric power transmitting apparatus, the electric power receiving apparatus receives a power test transmission from the electric power transmitting apparatus and thereafter notifies the electric power transmitting apparatus of the reception level at the time of the electric power transmission by means of a reception level notification. The electric power receiving apparatus stores electric power transmitting apparatus address 1707 stored as data in the power test transmission notification, and reception level 1708 determined by reception level determining section 221, as data 1704. Further, the electric power receiving apparatus fills destination address 1702 for broadcasting with zeros, and transmits packet 1700 as a reception level notification.

FIG. 17H is a configuration example of a packet used for information communication when transmitting a electric power transmission method notification. In this case, code 1703 is 0x20.

The electric power transmitting apparatus sends the electric power transmission method notification to a electric power receiving apparatus when the electric power transmission method is changed. The electric power transmitting apparatus stores the address of the target electric power receiving apparatus in destination address 1702, stores code 1709 indicating the electric power transmission method and electric power transmitting apparatus address 1710 of the electric power transmitting apparatus to perform electric power transmission to the target electric power receiving apparatus as data, and transmits the packet as a electric power transmission method notification. At this time, in the case of receiving power transmitted from a plurality of electric power transmitting apparatuses, the electric power transmitting apparatus stores a plurality of electric power transmitting apparatus addresses 1710 together with the number of electric power transmitting apparatuses in the data region.

FIG. 17I is table 1711 that shows codes representing electric power transmission methods. As described above, the present embodiment includes an individual mode, a hybrid mode, and a compound mode as electric power transmission methods. For example, the individual mode is specified by the code 0x01.

As described above, as operation modes, electric power transmitting apparatus 300 according to the present embodiment has a main electric power transmission mode that transmits power to a electric power receiving apparatus, and a sub-electric power transmission mode that transmits power of a smaller amount than an amount of power that is transmitted in the main electric power transmission mode. Further, in the sub-electric power transmission mode, electric power transmission control section 320 controls the timing of electric power transmission so that electric power transmission is performed at random time intervals. Therefore, when there is not sufficient power remaining in electric power receiving apparatus 200, electric power receiving apparatus 200 can send a power request notification signal using power transmitted in the sub-electric power transmission mode. Consequently, electric power transmitting apparatus 300 can start electric power transmission efficiently (individual mode). In addition, according to electric power transmitting apparatus 300 of the present embodiment, electric power transmission can be performed simultaneously from a plurality of electric power transmitting apparatuses 300 while a plurality of electric power transmitting apparatuses and electric power receiving apparatuses mainly utilize magnetic-field resonance of the same frequency as a electric power transmission frequency. Further, since electric power transmitting apparatus 300 that utilizes a single frequency performs electric power transmission irregularly at random time intervals the sub-electric power transmission mode, interference can be reduced.

Further, in electric power receiving apparatus 200 according to the present embodiment, reception level determining section 221 monitors the power reception state, and detects the occurrence of interference based on a change in the power reception state. Communication section 224 sends information showing the power reception state or an interference detection result indicating the occurrence of interference to electric power transmitting apparatus 300. In electric power transmitting apparatus 300 according to the present embodiment, triggered by reception of the interference detection notification, electric power transmission control section 320 switches the operation mode from the main electric power transmission mode to the sub-electric power transmission mode. Subsequently, after determining the electric power transmitting apparatus used to transmit power to electric power receiving apparatus 200, determination section 330 switches the operation mode from the sub-electric power transmission mode to the main electric power transmission mode. It is thereby possible for electric power receiving apparatus 200 to reduce interference and receive power from the optimal electric power transmitting apparatus 300 (hybrid mode).

Further, in electric power transmitting apparatus 300 according to the present embodiment, based on reception levels showing power reception states between electric power receiving apparatus 200 and electric power transmitting apparatus 300 and other electric power transmitting apparatuses, determination section 330 determines first and second electric power transmitting apparatuses to perform electric power transmission to electric power receiving apparatus 200 as well as output levels of the first and second electric power transmitting apparatuses. For example, based on reception levels showing power reception states between electric power receiving apparatus 200 and electric power transmitting apparatus 300 and other electric power transmitting apparatuses, determination section 330 determines a plurality of combinations of an output level of the first electric power transmitting apparatus and an output level of the second electric power transmitting apparatus. Subsequently, electric power transmission control section 320 sequentially selects pairs one by one from the plurality of determined combinations, and switches the output levels of the first and second electric power transmitting apparatuses in accordance with the selected combination (compound mode). Thus, electric power receiving apparatus 200 and other electric power receiving apparatuses can receive power via electric power transmission, and a reduction in the transmission efficiency can be avoided.

Although in the above description, reception level determining section 221 monitors the power reception state based on the state of power supplied from regulator/rectifier section 212, the present embodiment is not limited to this configuration. A configuration may also be adopted in which, instead of monitoring the power reception state based on power supplied from regulator/rectifier section 212, reception level determining section 221 monitors the power reception state based on a ratio of the degree of power obtained at the time of a power test transmission with respect to the amount of power needed by the electric power receiving apparatus.

Further, the efficiency of the overall system can be improved by excluding a electric power transmitting apparatus at which satisfactory electric power transmission cannot be obtained from any electric power transmitting apparatus from calculation of a decision algorithm for the electric power transmission method.

In the foregoing description, according to the compound mode, a change in the output level of a electric power transmitting apparatus is virtually realized by lowering reception level of a electric power receiving apparatus and the change is utilized to make a determination. However, the present invention is not limited to this configuration. For example, a configuration may also be adopted in which a electric power transmitting apparatus actually transmits power at various output levels, and determines a electric power transmission method by utilizing results of reception levels notified from a electric power receiving apparatus.

Further, although in the foregoing description an example is described in which the compound mode causes two electric power transmitting apparatuses to operate in conjunction and determines two pairs of combinations with respect to the output levels of the two electric power transmitting apparatuses, the present embodiment is not limited to this configuration. The compound mode may also be configured to combine output levels of three or more electric power transmitting apparatuses and sequentially switch between the different combinations.

Furthermore, in the above description, a case has been described in which electric power transmission control section 320 alternately switches between combinations of output levels of two electric power transmitting apparatuses in chronological order. Note that a configuration may also be adopted in which, based on an amount of power required by a charger, electric power transmission control section 320 changes a time interval or switching timing at which to alternately switch between the aforementioned combinations in chronological order. As a result, the present embodiment can perform even more effective electric power transmission.

The disclosure of the specification, the drawings, and the abstract included in Japanese Patent. Application No. 2011-031867 filed on Feb. 17, 2011, is incorporated herein by reference in its entirety.

### INDUSTRIAL APPLICABILITY

In a wireless electric power transmission system in which a plurality of electric power transmitting apparatuses and electric power receiving apparatuses mainly utilize the same frequency as a electric power transmission frequency, a electric power transmitting apparatus and the like according to the present invention allow electric power transmission, to be started even in a case where a electric power receiving apparatus does not have even enough remaining power to request electric, power transmission. Consequently, the electric power transmitting apparatus and the like according to the present invention are useful as a charging system of a mobile terminal and the like. Further, the electric power transmitting apparatus and the like according to the present invention can also be applied to an application such as a charging system of electrical household appliances, electric automobiles, and electric bicycles.

### REFERENCE SIGNS LIST

101 to 103, 300 Electric power transmitting apparatus
104, 105, 200 Electric power receiving apparatus
210 Power reception processing section
211 Power receiving section
212 Regulator/rectifier section.
213 Loading/charging section
220 Power reception control section
221 Reception level determining section
222 Control section
223 Device authentication section
224, 350 Communication section
310 Power transmitting section
320 Electric power transmission control section
330 Determination section
331 Device interrelationship judgment section
332 Electric power receiving apparatus management section
340 Device authentication section

1. A electric power transmitting apparatus that has a sub-electric power transmission mode, and a main electric power transmission mode in which a larger amount of power than an amount of power transmitted in the sub-electric power transmission mode is transmitted, and that transmits power to a electric power receiving apparatus in a manner in which a plurality of electric power transmitting apparatuses and electric power receiving apparatuses mainly utilize an identical frequency as a electric power transmission frequency, the electric power transmitting apparatus comprising:
a power transmitting section that transmits power wirelessly;
a communication section that acquires a power request notification to be transmitted from the electric power receiving apparatus; and
a electric power transmission control section that, as the sub-electric power transmission mode, controls power to be transmitted by the power transmitting section and a transmission timing of the power so that at least power required for the electric power receiving apparatus to transmit the power request notification is transmitted at random time intervals, and that switches to the main electric power transmission mode in a case where the communication section acquires the power request notification.

2. The electric power transmitting apparatus according to claim 1, wherein:
in the main electric power transmission mode, the communication section acquires an interference detection notification which indicates an occurrence of interference and which is transmitted from a first electric power receiving apparatus that has received power, and in the sub-electric power transmission mode, the communication section acquires information of first and second reception levels showing power reception states between the first electric power receiving apparatus and the electric power transmitting apparatus, and another electric power transmitting apparatus; and
the electric power transmitting apparatus further comprises a determination section that determines, based on the first and second reception levels, a first electric power transmitting apparatus to transmit power to the first electric power receiving apparatus, wherein
the electric power transmission control section, triggered by acquisition of the interference detection notification, switches from the main electric power transmission mode to the sub-electric power transmission mode, and after the determination section determines a electric power transmitting apparatus to transmit power to the first electric power receiving apparatus, the electric power transmission control section switches from the sub-electric power transmission mode to the main electric power transmission mode.

3. The electric power transmitting apparatus according to claim 2, wherein:
the communication section further acquires information of third and fourth reception levels showing power reception states between a second electric power receiving apparatus and the electric power transmitting apparatus, and the other electric power transmitting apparatus;
the determination section determines, based on the first, second, third, and fourth reception levels, first and second electric power transmitting apparatuses to transmit power to the first electric power receiving apparatus and output levels of the first and second electric power transmitting apparatuses in the main electric power transmission mode; and
the electric, power transmission control section controls, based on the determined output levels, the power to be transmitted by the power transmitting section.

4. The electric power transmitting apparatus according to claim 3, wherein:
the determination section determines, based on the first, second, third, and fourth reception levels, a plurality of combinations of an output level of the first electric power transmitting apparatus and an output level of the second electric power transmitting apparatus and
the electric power transmission control section selects pairs one by one sequentially from the plurality of combinations, and switches the output levels of the first and second electric power transmitting apparatuses in accordance with the selected combination.

5. The electric power transmitting apparatus according to claim 3, wherein the determination section determines a combination of the output levels of the first and second electric power transmitting apparatuses so that no interference occurs at the first electric power receiving apparatus and the second electric power receiving apparatus.

6. A electric power receiving apparatus that receives, from a electric power transmitting apparatus, power transmitted in a manner in which a plurality of electric, power transmitting apparatuses and electric power receiving apparatuses mainly utilize an identical frequency as a electric power transmission frequency, the electric power transmitting apparatus having a main electric power transmission mode, and a sub-electric power transmission mode in which a smaller amount of power than an amount of power transmitted in the main electric power transmission mode is transmitted, the electric power receiving apparatus comprising:
a power receiving section that receives power transmitted wirelessly from the electric power transmitting apparatus;
a reception level determining section that monitors a power reception state at the power receiving section and that detects an occurrence of interference based on a change in the power reception state; and
a communication section that sends a power request notification, information showing the power reception state, or an interference detection notification that indicates the occurrence of interference to the electric power transmitting apparatus.

7. A electric power transmitting method that transmits power from a electric power transmitting apparatus to a electric power receiving apparatus in a manner in which a plurality of electric power transmitting apparatuses and electric power receiving apparatuses mainly utilize an identical frequency as a electric power transmission frequency, the electric power transmitting apparatus having a sub-electric power transmission mode and a main electric power transmission mode in which a larger amount of power than an amount of power transmitted in the sub-electric power transmission mode is transmitted, the electric power transmitting method comprising:
transmitting power wirelessly;
acquiring a power request notification to be transmitted from the electric power receiving apparatus;
controlling, as the sub-electric power transmission mode, power to be transmitted and a transmission timing of the power so that at least power required for the electric power receiving apparatus to transmit the power request notification is transmitted at random time intervals; and
switching to the main electric power transmission mode in a case where the power request notification is acquired.
